(19) United States
(12) Patent Application Publication
(10) Pub. No.: US 2024/0067812 A1
(43) Pub. Date: Feb. 29, 2024

(54) MOISTURE-CURABLE SEMICONDUCTIVE FORMULATION

(71) Applicant: Dow Global Technologies LLC, Midland, MI (US)

(72) Inventors: Paul J. Caronia, Annadale, NJ (US); Jeffrey M. Cogen, Flemington, NJ (US); Bharat I. Chaudhary, Princeton, NJ (US); Timothy J. Person, Pottstown, PA (US); Suh Joon Han, Schwenksville, PA (US)

(21) Appl. No.: 18/258,878

(22) PCT Filed: Mar. 23, 2022
(86) PCT No.: PCT/US2022/021464

§ 371 Date: Jun. 22, 2023

Related U.S. Application Data
(60) Provisional application No. 63/168,343, filed on Mar. 31, 2021.

(51) Int. Cl. C08L 43/04; C08K 3/04

(52) U.S. Cl. CPC C08L 43/04; C08K 3/04; C08L 2203/20; C08L 2312/08

(57) ABSTRACT

A moisture-curable semiconductive formulation consisting essentially of a polyethylene-based polymer blend (uncured) and a conventional carbon black. The polyethylene-based polymer blend comprises a mixture of an ethylene/(alkenyl-functional hydrolyzable silane)/(optional olefinic hydrocarbon) copolymer and an ethylene/unsaturated carboxylic ester copolymer that is free of moisture curable groups. We also discovered methods of making and using same, a moisture-cured semiconductive product made therefrom, and articles containing or made from same.

### FIELD

Polyethylene-containing semiconductive materials, methods, and articles.

### INTRODUCTION

Patent application publications in or about the field include CA 2161991A1; CN105754185A; CN 105949547A; EP 2 889 323 A1; EP 2 910 595 A1; US 2003/0109494 A1; US 2003/0134969 A1; US 2008/0176981 A1; US 2009/0166925 A1; US 2010/0056809 A1; US 2010/0206607 A1; US 2011/0282024 A1; US 2013/0206453 A1; US 2015/0166708 A1; US 2016/0200843 A1; US 2021/0002452 A1; US 2021/0002464 A1; US 2021/0005344 A1; WO 2000/071094 A1; WO 2005/110123 A1; WO 2007/092454 A1; and WO 2011/094055 A1. Patents in the field include U.S. Pat. Nos. 5,266,627; 5,686,546; 6,080,810; 6,162,419; 6,277,303 B1; U.S. Pat. No. 6,284,832 B1; U.S. Pat. No. 6,331,586 B1; U.S. Pat. No. 6,830,777 B2; U.S. Pat. No. 6,936,655 B2; U.S. Pat. No. 7,390,970 B2; U.S. Pat. No. 7,767,910 B2; U.S. Pat. No. 9,595,365 B2; and U.S. Pat. No. 9,790,307 B2. Journal publications in the field include G. I. Razd'yakonova, et al., Comparison of the physiochemical properties of similar grades of carbon black, Kauchuk i Rezina, 2015, no. 2, pages 10 to 13, (as reported therein to be translated into English by P. Curtis from International Polymer Science and Technology, 42, No. 8, 2014, reference KR 15/02/10; transl. serial no. 17423).

### SUMMARY

We provide an improved moisture-curable semiconductive formulation and crosslinked semiconductive product, made therefrom by moisture curing, that address one or more drawbacks of the prior art. This is done at least in part by excluding offending materials. The present inventors provide a new moisture-curable semiconductive formulation and a new crosslinked semiconductive product made therefrom by moisture curing. The moisture-curable semiconductive formulation consists essentially of a polyethylene-based polymer blend (uncured) and a conventional carbon black. The polyethylene-based polymer blend comprises a mixture of an ethylene/(alkenyl-functional hydrolyzable silane)/(optional olefinic hydrocarbon) copolymer (moisture curable) and an ethylene/unsaturated carboxylic ester copolymer that is free of moisture curable groups such as groups derived from a hydrolyzable silane (and not moisture curable). Also methods of making and using same, a moisture-cured semiconductive product made therefrom, and articles containing or made from same.

The present formulation and product do not include (i.e., exclude) an ethylene/hydrolyzable silane/polar comonomer terpolymer, do not include (i.e., exclude) a crosslinking agent that is a polyorganosiloxane (also known as an organopolysiloxane) containing two or more functional end groups, such as two or more hydroxyl (HO—) end groups, and do not include (i.e., exclude) ultra-low wettability carbon black. The present formulation and product use a conventional carbon black and yet achieve excellent performance when used in semiconductive layers of electrical power cables. Without being bound by theory it is believed that in a power cable having a semiconductive layer made of the present crosslinked semiconductive product, the semiconductive layer does not suffer high moisture uptake during operational use of the power cable. The present formulation and product have sufficiently high content of conventional carbon black so as to achieve low volume resistivity at two different test temperatures (90° C. and 130° C.), which are similar to temperatures encountered during operation of power cables. The present formulation and product enable electrical percolation in the semiconductive layer of the power cable. And yet the present formulation and product enable a reduced carbon black content to be used therein without destroying desirable electrical properties of the semiconductive layer. Thus, the present formulation and product with a conventional carbon black surprisingly can achieve electrical and mechanical performance as good as or better than that obtained with the ultra-low wettability carbon black (e.g., as good as or better than LITX 50 carbon black).

### DETAILED DESCRIPTION

The Summary and Abstract are incorporated here by reference.

A moisture-curable semiconductive formulation consisting essentially of a polyethylene-based polymer blend (uncured) and a conventional carbon black. The polyethylene-based polymer blend comprises a mixture of an ethylene/(alkenyl-functional hydrolyzable silane)/(optional olefinic hydrocarbon) copolymer (moisture curable) and an ethylene/unsaturated carboxylic ester copolymer that is free of moisture curable groups such as groups derived from a hydrolyzable silane (and not moisture curable). Also methods of making and using same, a moisture-cured semiconductive product made therefrom, and articles containing or made from same. The optional olefinic hydrocarbon is not ethylene and may be present or absent.

The inventive formulation and product have excellent properties that make them well suited for use as semiconductive layers of power cables containing same. The excellent performance of the present formulation and product comprises a volume resistivity measured separately at 90° C. and 130° C. of less than 100,000 Ohm-centimeters (Ohm-cm; a power cable industry requirement) each, especially less than 1,000 Ohm-cm; a low-temperature brittleness failure at less than or equal to −25° C. (a power cable industry requirement); and passes the Wafer Boil Test (a power cable industry requirement). The performance of the present formulation and product may also comprise an elongation of greater than 100% after 7 days at 121° C., a surface roughness, Rₐ, of less than 2.06 micrometers (μm) (less than 81 microinches), and extrusions that have no scorch lumps.

Excluded materials. The following materials are or optionally may be, as the case may be, excluded from the moisture-curable semiconductive formulation, and the crosslinked semiconductive product made therefrom. Are excluded: an ethylene/hydrolyzable silane/polar comonomer terpolymer, a polyorganosiloxane (also known as an organopolysiloxane) containing two or more functional end groups (such as two or more hydroxyl end groups), and ultra-low wettability carbon black (such as LITX 50 and LITX 200). Optionally may be excluded: metal oxides (e.g., alumina hydrates) and/or carboxylic acids and salts thereof.

The phrases “consisting essentially of” and “consists essentially of” are partially-closed ended and mean that the moisture-curable semiconductive formulation, and the crosslinked semiconductive product made therefrom are free of the excluded materials. For example, are free of an ethylene/hydrolyzable silane/polar comonomer terpolymer, free of a polyorganosiloxane (also known as an organopolysiloxane) containing two or more functional end groups (such as two or more hydroxyl end groups), and free of ultra-low wettability carbon black (such as LITX 50 and LITX 200). Use of the term “comprises” or “comprising” in referring to a material or feature that follows does not negative the partially closed ended nature of the “consisting essentially of” or “consists essentially of”, but merely allows any additional material or feature that is not explicitly excluded by the “consisting essentially of” or “consists essentially of”.

Some, but not all, embodiments (aspects) are numbered for easier referencing.

Aspect 1. A moisture-curable semiconductive formulation consisting essentially of from 40.0 to 70.0 weight percent (wt %) of (A) an ethylene/(alkenyl-functional hydrolyzable silane)/(optional olefinic hydrocarbon) copolymer (“(A) Curable Copolymer” or, simply, “(A)”; moisture curable); from 16 to 34 wt % of (B) an ethylene/unsaturated carboxylic ester copolymer that is free of moisture curable groups (such as groups derived from a hydrolyzable silane) (“(B) Polar Copolymer”, or, simply, “(B)”; not moisture curable); from 14.0 to 30.0 wt % of (C) a conventional carbon black (“(C) Carbon Black”, or, simply, “(C)”; is not the ultra-low wettability carbon black); and a total amount of from 0 to 30.0 wt % of (X) at least one additive, which is not selected from (A), (B), and (C); wherein the composition (i.e., the total constituent unit composition) of the (A) ethylene/(alkenyl-functional hydrolyzable silane)/(optional olefinic hydrocarbon) copolymer is from 58.5 to 99.5 wt % of ethylenic units, from 0.5 to 5.0 wt % of comonomeric units derived from the alkenyl-functional hydrolyzable silane, and from 0 to 40 wt % of comonomeric units derived from one or more olefinic hydrocarbons, all based on weight of (A); wherein the (A) ethylene/(alkenyl-functional hydrolyzable silane)/(optional olefinic hydrocarbon) copolymer has a melt index (I₂, 190° C., 2.16 kg) from 1.0 to 2.0 grams per 10 minutes (g/10 min.), alternatively from 1.2 to 1.7 g/10 min.; wherein the composition (i.e., total constituent unit composition) of the (B) ethylene/(unsaturated carboxylic ester)(optional olefinic hydrocarbon) copolymer is from 60 to 95 wt % of ethylenic units and from 5 to 40 wt % of comonomeric units derived from the unsaturated carboxylic ester, and from 0 to 40 wt % of comonomeric units derived from one or more olefinic hydrocarbons, all based on weight of (B); wherein the (C) Carbon Black has either: a Brunauer, Emmett and Teller (BET) total surface area (“BET-1”) from 205 to 840 square meters per gram (m²/g) measured by a multipoint nitrogen adsorption method according to ASTM D6556-19a (Standard Test Method for Carbon Black—Total and External Surface Area by Nitrogen Adsorption), or an oil absorption number (“OAN-1”) of greater than 185 milliliters oil per 100 grams carbon black (mL/100 g) measured according to ASTM D2414-19 (Standard Test Method for Carbon Black—Oil Absorption Number (OAN)), or both BET-1 and OAN-1; wherein the (X) at least one additive comprises (D) a silanol condensation catalyst and/or (E) an antioxidant; and wherein the wt % of (A) in the formulation and the wt % of the comonomeric units derived from the alkenyl-functional hydrolyzable silane in (A) together are sufficient such that the amount of the comonomeric units derived from the alkenyl-functional hydrolyzable silane is from 0.7 to 3.0 wt % of the formulation; and wherein the formulation has a volume resistivity measured at 130° C. of less than 100,000 Ohm-centimeters (Ohm-cm), as measured according to the Volume Resistivity Test Method. In making the formulation the (C) Carbon Black is mixed into a pre-made blend of the (A) ethylene/(alkenyl-functional hydrolyzable silane)/(optional olefinic hydrocarbon) copolymer and the (B) ethylene/unsaturated carboxylic ester copolymer. In some embodiments the formulation contains from 43 to 68 wt % of (A), from 16 to 34 wt % of (B), from 14.0 to 30.0 wt % of (C), and from 0 to 27 wt % of the (X).

Aspect 2. The moisture-curable semiconductive formulation of aspect 1 wherein the (A) Curable Copolymer has any one of limitations (i) to (v): (i) the optional olefinic hydrocarbon is absent (i.e., is 0.0 wt % of (A)) and the (A) ethylene/(alkenyl-functional hydrolyzable silane)/(optional olefinic hydrocarbon) copolymer is an ethylene/(alkenyl-functional hydrolyzable silane) copolymer; (ii) the optional olefinic hydrocarbon is present (i.e., is from 0.1 to 40 wt % of (A)) and is a (C₃-C₄₀)alpha-olefin and the (A) ethylene/(alkenyl-functional hydrolyzable silane)/(optional olefinic hydrocarbon) copolymer is an ethylene/(alkenyl-functional hydrolyzable silane)/(C₃-C₄₀)alpha-olefin copolymer; (iii) the alkenyl-functional hydrolyzable silane (comonomer used to make (A)) is of formula H₂C═C(R^{a})—((C₁-C₂₀)alkylene)ₖ-(C═O)ⱼ—((C₁-C₂₀)alkylene)ₖ-Si(R)ₘ(R¹)₃₋ₘ, wherein subscript j is 0 or 1; subscript k is 0 or 1; subscript m is 1, 2, or 3; R^{a} is H or methyl; each R independently is H, hydroxyl (—OH), an alkoxy, a carboxy, an N,N-dialkylamino, an alkyloximo, or a dialkyloximo; and each R¹ independently is hydrocarbyl; (iv) both (i) and (iii); and (v) both (ii) and (iii). In some embodiments the (A) Curable Copolymer is from 48.0 to 63.0 wt % of the formulation.

Aspect 3. The moisture-curable semiconductive formulation of aspect 1 or 2 wherein the (B) Polar Copolymer has any one of limitations (i) to (vii): (i) (B) is an ethylene/ethyl acrylate copolymer or an ethylene/butyl acrylate copolymer; (ii) (B) is an ethylene vinyl acetate (EVA) copolymer; (iii) (B) is a blend of EEA and EVA, a blend of EBA and EVA, or a blend or EEA and EBA; (iv) (B) is from 16 to 22 wt % (e.g., 19 wt %) of the formulation; (v) (B) is from 26 to 32 wt % (e.g., 29 wt %) of the formulation; (vi) both (i) and (iv); and (vii) both (i) and (v). In some embodiments the (B) Polar Copolymer is from 19.0 to 29.4 wt % of the formulation.

Aspect 4. The moisture-curable semiconductive formulation of any one of aspects 1 to 3 wherein the (C) Carbon Black has any one of limitations (i) to (vi): (i) the BET total surface area BET-1 is from 61 to 69 m²/g (e.g., 65 m²/g) and the oil absorption number OAN-1 is greater than 185 mL/100 g, alternatively from 186 to 194 mL/100 g (e.g., 190±2 mL/100 g); (ii) the BET total surface area BET-1 is from 221 to 259 m²/g (e.g., 223 to 254 m²/g) and the oil absorption number OAN-1 is greater than 170 mL/100 g, alternatively greater than 185 mL/100 g, alternatively from 190 to 194 mL/100 g (e.g., 192±1 mL/100 g); (iii) the BET total surface area BET-1 is from 321 to 349 m²/g (e.g., 335 m²/g) and the oil absorption number OAN-1 is greater than 170 mL/100 g, alternatively greater than 185 mL/100 g, alternatively greater than 191 mL/100 g; (iv) the BET total surface area BET-1 is from 755 to 844 m²/g (e.g., 800 m²/g) and the oil absorption number OAN-1 is from 300 to 390 mL/100 g, alternatively from 328 to 348 mL/100 g (e.g., 338±4 mL/100 g); (v) the oil absorption number OAN-1 is greater than 185 mL/100 g, alternatively from 186 to 194 mL/100 g (e.g., 191±2 mL/100 g); (vi) the (C) Carbon Black is a furnace black. In some embodiments the (C) Carbon Black is described by a combination of limitation (vi) and any one of limitations (i) to (v). In some embodiments the (C) Carbon Black is from 14.0 to 29.4 wt % of the formulation.

Aspect 5. The moisture-curable semiconductive formulation of any one of aspects 1 to 4 wherein the (X) at least one additive is present in the formulation (i.e., total amount of (X) is from 0.1 to 30 wt % of the formulation) and comprises the (D) silanol condensation catalyst and the (E) antioxidant; and optionally (F) a carrier resin (e.g., a low-density polyethylene or high-density polyethylene), (G) a metal deactivator (e.g., oxalyl bis(benzylidene)hydrazide (OABH)), or (H) a moisture scavenger, or a combination of any two or more of (F) to (H). In some embodiments the total amount of the (X) at least one additive is from 0.1 to 20.0 wt % of the formulation. In other embodiments the (X) at least one additive is absent (i.e., total amount of (X) is 0.00 wt % of the formulation).

Aspect 6. A method of making a moisture-curable semiconductive formulation of any one of aspects 1 to 5, the method comprising mixing the (C) Carbon Black into the (A) ethylene/(alkenyl-functional hydrolyzable silane)/(optional olefinic hydrocarbon) copolymer and (B) ethylene/(unsaturated carboxylic ester)(optional olefinic hydrocarbon) copolymer in such a way so as to make the moisture-curable semiconductive formulation. In some embodiments the method comprises mixing the (C) into a pre-made blend of (A) and (B). When the formulation also contains the (X) at least one additive, the mixing step may further comprise mixing the (X) at least one additive into the (A) and (B). In some embodiments the (A) and (B) may be the pre-made blend. In other embodiments the (A) and/or (B), or the pre-made blend thereof, may already contain the (X) at least one additive, with the proviso that any (X) already contained in (A) or in the pre-made blend of (A) and (B), is not the (D) silanol condensation catalyst. The amounts of the ingredients (A), (B), (C), and (X), if any, are sufficient for achieving the claimed wt % of the constituents (A), (B), (C), and (X), if any. The method may further comprise a preliminary step before the mixing step of blending together the (A) ethylene/(alkenyl-functional hydrolyzable silane)/(optional olefinic hydrocarbon) copolymer and the (B) ethylene/unsaturated carboxylic ester copolymer in such a way so as to make the pre-made blend. The pre-made blend may then be used in the mixing step.

Aspect 7. A moisture-cured semiconductive product that is made by (i.e., is a reaction product of) moisture curing the moisture-curable semiconductive formulation of any one of aspects 1 to 5 to give the moisture-cured semiconductive product, which has a crosslinked polyethylene network made by cross-linking molecules of the (A) ethylene/(alkenyl-functional hydrolyzable silane)/(optional olefinic hydrocarbon) copolymer and wherein the crosslinked polyethylene network contains dispersed therein the (B) ethylene/(unsaturated carboxylic ester)(optional olefinic hydrocarbon) copolymer and the (C) Carbon Black, and, optionally (i.e., if present), the (X) at least one additive. If the (X) at least one additive is present in the formulation, it is deemed to be present in the product made therefrom. Conversely, it the (X) at least one additive is absent from the formulation, it is deemed to be absent from the product made therefrom.

Aspect 8. The moisture-cured semiconductive product of aspect 7 having any one of the following properties (i) to (vii): (i) a gel content of greater than 40.0 wt %, alternatively greater than 50.0 wt %, alternatively greater than 60.0 wt %, alternatively from 41 to 70.0 wt %, alternatively from 41 to 60.0 wt %, alternatively from 44 to 59 wt %, alternatively from 41 to 47 wt %, alternatively from 55 to 60.0 wt %, all as measured according the Gel Content Test Method, described later; (ii) a volume resistivity measured separately at 90° C. and 130° C. of less than 10,000 Ohm-centimeters (Ohm-cm) each, especially less than 1,000 Ohm-cm, alternatively from 1 to 110 Ohm-cm at 90° C., alternatively from 1 to 99 Ohm-cm at 90° C., alternatively from 2 to 32 Ohm-cm at 90° C., alternatively from 1 to 810 Ohm-cm at 130° C., alternatively from 1 to 110 Ohm-cm at 130° C., alternatively from 1 to 80 Ohm-cm at 130° C., all as measured according to the Volume Resistivity Test Method, described later; (iii) an elongation of greater than 100.0% after 7 days at 121° C., measured according to the Elongation Test Method, described later; (iv) a low-temperature brittleness failure at less than or equal to −25° C., alternatively at ≤−30° C., determined according to the Low-Temperature Brittleness Test Method, described later; (v) surface roughness, Rₐ, of less than 2.06 μm (81 microinches) microinches), wherein Rₐ is the arithmetic average deviation above and below a center line of a stylus passing over the surface of a crosslinked product (e.g., crosslinked extruded tape or crosslinked coated wire), alternatively less than 2.01 μm (less than 79 microinches), alternatively less than 1.91 μm (less than 75 microinches), alternatively less than 1.83 μm (less than 72 microinches), alternatively less than 0.99 μm (less than 39 microinches), alternatively less than 0.89 μm (less than 35 microinches), alternatively less than 0.759 μm (less than 29.9 microinches), and optionally at least 0.35 μm, all measured according to the Surface Roughness Test Method, described later; (vi) free of scorch lumps as determined according to the Scorch Lumps on Wire Insulation Test Method, described later; and (vii) passes the Wafer Boil Test as determined according to the Wafer Boil Test Method, described later. In some embodiments the moisture-curable semiconductive formulation and/or the moisture-cured semiconductive product made therefrom has a combination of any two or more properties (i) to (vii). In some embodiments the combination of two or more properties is any one of (viii) to (xxx): (viii) both (i) and (ii); (ix) both (i) and (iii); (x) both (i) and (iv); (xi) both (i) and (v); (xii) both (i) and (vi); (xiii) both (i) and (vii); (xiv) both (ii) and (iii); (xv) both (ii) and (iv); (xvi) both (ii) and (v); (xvii) both (ii) and (vi); (xviii) both (ii) and (vii); (xix) both (iii) and (iv); (xx) both (iii) and (v); (xxi) both (iii) and (vi); (xxii) both (iii) and (vii); (xxiii) both (iv) and (v); (xxiv) both (iv) and (vi); (xxv) both (iv) and (vii); (xxvi) both (v) and (vi); (xxvii) both (v) and (vii); (xxviii) both (vi) and (vii); (xxix) any six of (i) to (vii) (omitting any one of properties (i) to (vii)); and (xxx) each of (i) to (vii). Without being bound by theory, it is believed that if the gel content of the product is less than 40 wt %, or less than 50.0 wt %, the product may fail the Wafer Boil Test. Passing the Wafer Boil Test may be required in order to meet standards for electrical power cables set by the industry.

Aspect 9. A manufactured article comprising a shaped form of the moisture-cured semiconductive product of aspect 7 or 8.

Aspect 10. A method of making the manufactured article of aspect 9, the method comprising shaping a melt of the moisture-curable semiconductive formulation to give a shaped moisture-curable semiconductive formulation, and then subjecting the shaped moisture-curable semiconductive formulation to moisture-curing conditions to give the manufactured article.

Aspect 11. A coated conductor comprising a conductive core and a semiconductive layer at least partially surrounding the conductive core, wherein at least a portion of the semiconductive layer comprises the moisture-cured semiconductive product of aspect 7 or 8. Typically the semiconductive layer consists of the moisture-cured semiconductive product and the semiconductive layer completely surrounds the conductive core except for the ends thereof.

Aspect 12. A method of making the coated conductor of aspect 11, the method comprising extruding a layer of a melt of the moisture-curable semiconductive formulation onto the conductive core to give a conductive core covered by the extruded layer of the moisture-curable semiconductive formulation, and then subjecting the extruded layer of moisture-curable semiconductive formulation to moisture-curing conditions to give the a coated conductor comprising the conductive core covered by the semiconductive layer.

Aspect 13. A method of conducting electricity, the method comprising applying a voltage across the conductive core of the coated conductor of aspect 11 so as to generate a flow of electricity through the conductive core.

Embodiments of the formulation and product meet power cable industry standards for surface roughness. Surface roughness measurements are reported in the Examples for either crosslinked (water bath cured) extruded tapes or on crosslinked (water batch cured) coated wires. Because extruded tapes are faster and easier to make than coated wires, roughness of extruded tapes is a useful early indication of surface roughness of power cables. The surface roughness measurements made on crosslinked coated wires are accepted as being more applicable to electrical power cable performance, and thus for characterizing the formulation and product by surface roughness, the measurements made on the crosslinked coated wires should be used. Said differently, if surface roughness of a crosslinked extruded tape lies outside the claimed range for Rₐ but the surface roughness of a crosslinked coated wire made from the same formulation lies inside the claimed range for Rₐ, the measurement made on the crosslinked coated wire controls.

Embodiments of the formulation and product meet power cable industry standards comprising a volume resistivity measured separately at 90° C. and 130° C. of less than 100,000 Ohm-centimeters (Ohm-cm) each, especially less than 1,000 Ohm-cm; an elongation of at least 100% after 7 days at 121° C.; a low-temperature brittleness failure at less than −25° C.; and pass the Wafer Boil Test. The volume resistivity limitation ensures that a semiconductive material composed of the formulation or product has adequate electrical charge dissipation performance for use in power cables. The elongation of at least 100% after 7 days at 121° C. ensures that cracks are not easily formed by bending the formulation or product. The low-temperature brittleness limitation ensures that cracks are not easily formed in the formulation or product if used at cold winter temperatures. In theory any elongation after 7 days at 121° C. of greater than 100% is useful, although in practice the maximum elongation after 7 days at 121° C. is usually less than 500.0%, alternatively less than 300.0%, alternatively less than 200.0%. The Wafer Boil Test ensures that the formulation makes a crosslinked polymer product that has sufficient extent of crosslinking to enable the product to maintain its geometry during a high temperature operation, such as during operation of power cables.

Embodiments of the formulation and product meet power cable industry standards for elongation. Elongation measurements are reported in the Examples for either aged extruded tapes or aged coated wires. Because extruded tapes are faster and easier to make than coated wires, elongation of extruded tapes is a useful early indication of elongation of power cables. The elongation measurements made on aged coated wires are accepted as being more applicable to electrical power cable performance, and thus for characterizing the formulation and product by elongation, the measurements made on the aged coated wires should be used. Said differently, if elongation of an aged tape lies outside the claimed range therefor, but the elongation of an aged coated wire made from the same formulation lies inside the claimed range therefor, the measurement made on the aged coated wire controls.

As indicated by the phrase “consisting essentially of”, the moisture-curable semiconductive formulation advantageously is free of an ethylene/hydrolyzable silane/polar comonomer terpolymer, free of a polyorganosiloxane (also known as an organopolysiloxane) containing two or more functional end groups (such as two or more hydroxyl end groups), and free of ultra-low wettability carbon black (such as LITX 50 and LITX 200).

The moisture-curable semiconductive formulation uses the (A) ethylene/(alkenyl-functional hydrolyzable silane)/(optional olefinic hydrocarbon) copolymer, which is free of polar comonomer (e.g., free of an unsaturated carboxylic ester comonomer) and yet it is believed that the formulation can accept higher loadings of the (C) Carbon Black and/or a wider variety of carbon blacks (low structure to high structure) compared to a comparative formulation that is identical except wherein the (B) Polar Copolymer is replaced by a same amount of either (A) Curable Copolymer or a low-density polyethylene (LDPE) polymer. Although a high-structure carbon black can be used as the (C) Carbon Black in the formulation, a high-structure carbon black is not required in order for the formulation to reach sufficient levels of electrical conductivity. In some embodiments the (C) Carbon Black is a “low-structure” carbon black. Structure of carbon black relates to the number of primary particles and the complexity of their structures. High-structure versus low-structure carbon blacks can be distinguished by their oil absorption number (OAN) values in that high-structure carbon blacks (i.e., carbon blacks having more complex structure) have more void spaces between particles, and thus absorb more oil than low-structure carbon blacks. That is, all other things being equal, the higher the OAN number of a carbon black, the greater is its structural complexity.

Without being bound by theory, it is believed that the (B) ethylene/(unsaturated carboxylic ester)(optional olefinic hydrocarbon) copolymer has an enhancing effect on the ability of the (A) ethylene/(alkenyl-functional hydrolyzable silane)/(optional olefinic hydrocarbon) copolymer to accept high loadings of the (C) Carbon Black. It is believed that the (B) Polar Copolymer enables the formulation to have a volume resistivity in Ohm-cm that is 10% lower, alternatively 25% lower, alternatively 50% lower at the same loading level (wt %) of the (C) Carbon Black and enables a same Ohm-cm volume resistivity to be achieved at a lower loading level (lower wt %) of the (C) Carbon Black in the formulation compared to volume resistivity performance of a comparative formulation that is identical except wherein the (B) Polar Copolymer is replaced by a same amount of either (A) Curable Copolymer, wherein volume resistivity is measured in Ohm-centimeters (Ohm-cm) at 130° C.

The moisture-curable semiconductive formulation beneficially enables greater degrees of process freedom or flexibility and requires fewer polymerizations when titrating the amount (wt %) of constituent units derived from the unsaturated carboxylic ester as a percentage of the total weight of the moisture-curable semiconductive formulation for a particular (C) Carbon Black or loading of (C) in the formulation. The amount (wt %) of constituent units derived from the unsaturated carboxylic ester as a percentage of the total weight of the moisture-curable semiconductive formulation is a function of the amount of the (B) ethylene/(unsaturated carboxylic ester)/(optional olefinic hydrocarbon) copolymer used therein and the weight fraction of the constituents units derived from the unsaturated carboxylic ester present in (B). Although the weight fraction of the constituent units derived from the unsaturated carboxylic ester in (B) cannot be easily adjusted (but would require conducting a new polymerization reaction to make a completely new (B) Polar Copolymer), advantageously, the wt % of the constituent units derived from the unsaturated carboxylic ester in the formulation can be easily adjusted by adding more or less of the already used (B) Polar Copolymer during the mixing step of the making of the formulation. Thus, in some embodiments the method of making the moisture-curable semiconductive formulation (of aspect 6) comprises mixing the (C) Carbon Black into the pre-made blend of the (A) ethylene/(alkenyl-functional hydrolyzable silane)/(optional olefinic hydrocarbon) copolymer and (B) ethylene/(unsaturated carboxylic ester)(optional olefinic hydrocarbon) copolymer in such a way so as to make a first moisture-curable semiconductive formulation of any one of aspects 1 to 5, wherein the first moisture-curable semiconductive formulation has a first wt % of constituent units derived from the unsaturated carboxylic ester; and adding an additional amount of the (B) Polar Copolymer to the first formulation, thereby making a second moisture-curable semiconductive formulation of any one of aspects 1 to 5, wherein the second moisture-curable semiconductive formulation has a second wt % of constituent units derived from the unsaturated carboxylic ester, wherein the second wt % is at least 1.0 wt % higher, alternatively at least 2.0 wt % higher, alternatively at least 5 wt % higher, alternatively at least 9 wt % higher than the first wt %.

The moisture-curable semiconductive formulation enables extrusion of semiconductive layers thereof on a conductor core or on an insulation layer, wherein the extruded semiconductive layers have sufficient smoothness (low surface roughness). This is seen when the moisture-curable semiconductive formulation is extruded in the form of tapes or coated wires with sufficient smoothness under a variety of process conditions. The composition of the present formulation is extrudable under a variety of processing conditions and the extruded tapes and coated wires have been found to have satisfactory smoothness for use in electrical power cables. If the surface of a semiconductive layer of a power cable is too rough, the layer's ability to function to prolong service life of the electrical power cable by preventing or decreasing partial discharges at its interface with an adjacent component (e.g., the conductor core or insulation layer) is harmed or diminished. Inventive semiconductive layers made by extruding the moisture-curable semiconductive formulation are helpful for preventing such surface roughness-caused problems.

Moisture-curable semiconductive formulation. The moisture-curable polyolefin composition may be a one-part formulation, alternatively a multi-part formulation such as a two-part formulation. The two-part formulation may comprise first and second parts wherein constituents that may react prematurely with each other are kept separate in different parts or one or more of the (X) at least one additive may be kept in one part and constituents (A) to (C) in another part. For example, the (A) ethylene/(alkenyl-functional hydrolyzable silane)/(optional olefinic hydrocarbon) copolymer may be in a first part and the (D) silanol condensation catalyst, if present, may be in a second part. The total weight of all constituents in the moisture-curable semiconductive formulation is 100.00 wt %. For a multi-part formulation, the total weight of all parts equals the total weight of the formulation.

The wt % of (A) in the formulation and the wt % of the comonomeric units derived from the alkenyl-functional hydrolyzable silane in (A) together are sufficient such that the amount of the comonomeric units derived from the alkenyl-functional hydrolyzable silane is from 0.7 to 3.0 wt % of the formulation. In some embodiments the amount of the comonomeric units derived from the alkenyl-functional hydrolyzable silane is from 0.71 to 1.5 wt % of the formulation, alternatively from 0.73 to 1.3 wt % of the formulation, alternatively 0.71 to 1.24 wt % of the formulation. The amount of the comonomeric units derived from the alkenyl-functional hydrolyzable silane in the formulation may be determined by multiplying the wt % of constituent (A) in the formulation times the wt % of the comonomeric units derived from the alkenyl-functional hydrolyzable silane in constituent (A). The wt % of the comonomeric units derived from the alkenyl-functional hydrolyzable silane in constituent (A) may be determined by nuclear magnetic resonance (NMR) spectroscopy or by the relative amounts of ethylene, alkenyl-functional hydrolyzable silane, and, if any, olefinic hydrocarbons used in the copolymerization process of making (A).

The moisture-curable semiconductive formulation may be in a continuous (monolithic) or divided solid form. The divided form of the moisture-curable semiconductive formulation may comprise granules and/or pellets.

During curing the moisture-curable semiconductive formulation may further comprise water in liquid or vapor form. Rate of curing may be increased by heating the formulation, by including in the formulation the (D) silanol condensation catalyst, or both. For faster curing rates, the formulation comprises the (D) silanol condensation catalyst in the claimed amount (wt %) and the curing comprises heating the formulation with steam (vaporous water) to a temperature in the range from 300 to 300° C. such as can be done in a continuous vulcanization (CV) steam tube used in cable manufacturing. The curing of the formulation results in crosslinks (covalent bonds) formed between the moisture-curable groups of the (A) ethylene/(alkenyl-functional hydrolyzable silane)/(optional olefinic hydrocarbon) copolymer.

In some embodiments the moisture-curable semiconductive formulation may have greater than 24 particles per m² having a width of larger than 150 μm at the half height of the particle protruding from the surface of a tape sample made therefrom, greater than 11 particles per m² having a width larger than 200 μm at half height of a particle protruding from the surface of the tape sample, at least 2 particles per m² having a width greater than 500 μm at half height of the particle protruding from the surface of the tape sample, or all of the foregoing limitations.

The moisture-curable semiconductive formulation has less than 0.4 wt % of, alternatively completely free of (has 0 wt % of), a polyorganosiloxane (also known as an organopolysiloxane) containing two or more functional end groups. The functional end groups of the polyorganosiloxane containing two or more functional end groups may be hydroxyl (—OH) groups. Thus, the moisture-curable semiconductive formulation is substantially free of, alternatively completely free of, a polyorganosiloxane, such as a polydimethylsiloxane (PDMS), containing two or more HO— end groups. The crosslinked semiconductive product made therefrom are also free of such materials and are free of crosslinking groups formed from such materials.

In some embodiments the phrase “consisting essentially of” also means that the moisture-curable semiconductive formulation, and the crosslinked semiconductive product made therefrom, are free of a carboxylic acid of formula R—CO₂H, or a salt thereof (e.g., an amine or metal salt).

In some embodiments the phrase “consisting essentially of” also means that the moisture-curable semiconductive formulation, and the crosslinked semiconductive product made therefrom, are free of an alumina hydrate, including an alumina trihydrate. In some embodiments the formulation and product are free of any alumina, alternatively any inorganic metal oxide.

Constituent (A) ethylene/(alkenyl-functional hydrolyzable silane)/(optional olefinic hydrocarbon) copolymer. The (A) ethylene/(alkenyl-functional hydrolyzable silane)/(optional olefinic hydrocarbon) copolymer contains covalently-bonded moisture curable groups that are hydrolyzable silane groups. These moisture curable groups are present as constituent comonomeric units in backbones of main polymer chains, which backbones also contain ethylenic monomeric units and, if present, olefinic hydrocarbon constituent units. The moisture-curable copolymer is made by copolymerizing ethylene, alkenyl-functional hydrolyzable silane (comonomer), and, optionally, olefinic hydrocarbon (comonomer). The copolymerizing yields, and the resulting copolymer has, a random distribution of constituent units. Thus the copolymer has a random distribution of ethylenic units, comonomeric units derived from the alkenyl-functional hydrolyzable silane, and optionally comonomeric units derived from the olefinic hydrocarbon, if the latter is used.

The (A) Curable Copolymer may be a reactor copolymer of ethylene and the alkenyl-functional hydrolyzable silane and, optionally, the optional olefinic hydrocarbon. Constituent (A) may be made by copolymerizing the alkenyl-functional hydrolyzable silane with ethylene and, optionally, olefinic hydrocarbon monomer, in a high-pressure reactor. Suitable high pressure reactors are those used in the manufacture of ethylene homopolymers and ethylene copolymers with alkyl acrylates or vinyl acetate. In some embodiments the (A) Curable Copolymer is a reactor copolymer of ethylene and the alkenyl-functional hydrolyzable silane and is free of comonomeric units derived from an olefinic hydrocarbon that is not ethylene.

The hydrolyzable silane groups enable the crosslinking of the (A) ethylene/(alkenyl-functional hydrolyzable silane)/(optional olefinic hydrocarbon) copolymer upon exposure to water and, optionally, the (D) silanol condensation catalyst. The crosslinking comprises a condensation reaction between the hydrolyzable silane groups and water and between silanol groups (i.e., Si—OH groups) that are generated in situ thereby. The (D) silanol condensation catalyst enhances the rate of these condensation crosslinking reactions.

Any silane having at least one hydrolyzable group bonded to a silicon atom (“hydrolyzable silane”) and that is capable of being copolymerized with ethylene may be used as the alkenyl-functional hydrolyzable silane. Suitable hydrolyzable silanes include unsaturated hydrolyzable silanes that comprise an ethylenically unsaturated hydrocarbyl group, such as a vinyl, allyl, isopropenyl, butenyl, cyclohexenyl or gamma-(meth)acryloxy allyl group, and a hydrolyzable group, such as, for example, a hydrocarbyloxy, hydrocarbonyloxy, or hydrocarbylamino group. Examples of hydrolyzable groups include methoxy, ethoxy, formyloxy, acetoxy, proprionyloxy, and alkyl or arylamino groups. Preferred hydrolyzable silanes are the unsaturated alkoxy silanes which can be copolymerized in-reactor with other monomers (such as ethylene and alpha-olefins). These hydrolyzable silanes and their method of preparation are more fully described in U.S. Pat. No. 5,266,627 to Meverden, et al. Vinyl trimethoxy silane (VTMS), vinyl triethoxy silane, vinyl triacetoxy silane, gamma-(meth)acryloxy propyl trimethoxy silane and mixtures of these silanes are included. If filler is present in the formulation, then the hydrolyzable silane may be a vinyl trialkoxysilane.

In some embodiments the alkenyl-functional hydrolyzable silane is of formula H₂C═C(R^{a})—((C₁-C₂₀)alkylene)ₖ-(C═O)ⱼ—((C₁-C₂₀)alkylene)_{k′}-Si(R)ₘ(R¹)₃₋ₘ, wherein subscript j is 0 or 1; subscript k is 0 or 1; subscript k′ is 0 or 1; subscript m is 1, 2, or 3; R^{a} is H or methyl; each R independently is H, hydroxyl (—OH), an alkoxy, a carboxy, an N,N-dialkylamino, an alkyloximo, or a dialkyloximo; and each R¹ independently is hydrocarbyl. In some embodiments the alkenyl-functional hydrolyzable silane is of formula H₂C═C(H)—((C₁-C₂₀)alkylene)ₖ-Si(R)ₘ(R¹)₃₋ₘ or H₂C═C(CH₃)—((C₁-C₂₀)alkylene)ₖ-Si(R)ₘ(R¹)₃₋ₘ, alternatively H₂C═C(H)—((C₁-C₂₀)alkylene)ₖ-Si(R)ₘ(R¹)₃₋ₘ. In some embodiments subscript k is 0, alternatively 1. In some embodiments subscript m is 3, alternatively 2, alternatively 1. In some embodiments subscript k is 0 and subscript m is 3; alternatively subscript k is 0 and subscript m is 2; alternatively subscript k is 0 and subscript m is 1. In some embodiments subscript k is 1 and subscript m is 3; alternatively subscript k is 1 and subscript m is 2; alternatively subscript k is 1 and subscript m is 1. In some embodiments R^{a} is H, alternatively R^{a} is methyl. In some embodiments each R group independently is H, HO—, (C₁-C₆)alkoxy, (C₂-C₆)carboxy, ((C₁-C₆)alkyl)₂N—, (C₁-C₆)alkyl(H)C═NO—, or ((C₁-C₆)alkyl)₂C═NO—. In some embodiments each R¹ is independently alkyl or aryl, alternatively (C₁-C₆)alkyl or phenyl, alternatively alkyl, alternatively phenyl. In some embodiments each R group independently is (C₁-C₆)alkoxy, (C₂-C₆)carboxy, ((C₁-C₆)alkyl)₂N—, or ((C₁-C₆)alkyl)₂C═NO—; alternatively each R group is (C₁-C₆)alkoxy; alternatively each R group is (C₂-C₆)carboxy; alternatively each R group is ((C₁-C₆)alkyl)₂N—; alternatively each R group is ((C₁-C₆)alkyl)₂C═NO—. In some embodiments each R group independently is (C₁-C₆)alkoxy, alternatively methoxy, alternatively ethoxy, alternatively (C₃-C₆)alkoxy.

When R^{a} is H, subscripts k, k′, and j are each 0, alkenyl group in the alkenyl-functional hydrolyzable silane is vinyl.

The alkenyl-functional hydrolyzable silane may contain 1, 2, or 3 hydrolyzable groups. For example, in formula H₂C═C(R^{a})—((C₁-C₂₀)alkylene)ₖ-(C═O)ⱼ—((C₁-C₂₀)alkylene)ₖ-Si(R)ₘ(R¹)₃₋ₘ, when subscript m is 3 the alkenyl-functional hydrolyzable silane contains 3 hydrolyzable groups, when subscript m is 2, the alkenyl-functional hydrolyzable silane contains 2 hydrolyzable groups, and when subscript m is 1, the alkenyl-functional hydrolyzable silane contains 1 hydrolyzable group. A hydrolyzable Si—R bond means two such —SiR₃ groups, typically in different molecules of the (A) ethylene/(alkenyl-functional hydrolyzable silane)/(olefinic hydrocarbon) copolymer, are capable of reacting with a water molecule to form a Si—O—Si crosslink. Examples of such hydrolyzable groups bonded to silicon atom are a hydrogen atom (the Si—H bond is hydrolyzable), a hydroxyl (the Si—O bond in Si—OH is hydrolyzable), an alkoxy (Si-alkoxy is hydrolyzable), a carboxy (the Si—O bond in Si—O₂C-alkyl is hydrolyzable), a N,N-dialkylamino (the Si—N bond in Si—N(alkyl)₂ is hydrolyzable), an alkyloximo (the Si—O bond in Si—O—N═C(alkyl)(H) is hydrolyzable), or dialkyloximo (the Si—O bond in Si—O—N═C(alkyl)₂ is hydrolyzable).

In some embodiments the alkenyl-functional hydrolyzable silane may be a vinyl trialkoxysilane (VTAOS). The VTAOS may be vinyl trimethoxysilane (VTMAOS).

In some embodiments the (A) ethylene/(alkenyl-functional hydrolyzable silane)/(optional olefinic hydrocarbon) copolymer is free of constituent units derived from the olefinic hydrocarbon monomer.

In other embodiments the (A) ethylene/(alkenyl-functional hydrolyzable silane)/(optional olefinic hydrocarbon) copolymer contains one or more different types of constituent units derived from the olefinic hydrocarbon monomer. Each olefinic hydrocarbon monomer independently can be any hydrocarbon capable of being copolymerized with ethylene. In some embodiments there is only one type of olefinic hydrocarbon monomer. In some embodiments the olefinic hydrocarbon monomer is a (C₃-C₄₀)alpha-olefin. In some embodiments the (C₃-C₄₀)alpha-olefin is propylene; alternatively a (C₄-C₈)alpha-olefin, alternatively 1-butene or 1-hexene, alternatively 1-hexene or 1-octene, alternatively 1-butene, alternatively 1-hexene, alternatively 1-octene.

The composition of the (A) ethylene/(alkenyl-functional hydrolyzable silane)/(optional olefinic hydrocarbon) copolymer is from 58.5 to 99.5 wt % of ethylenic units, from 0.5 to 5.0 wt % of comonomeric units derived from the alkenyl-functional hydrolyzable silane, and from 0 to 40 wt % of comonomeric units derived from one or more olefinic hydrocarbons, all based on weight of (A). In some embodiments the ethylenic units are from 90 to 99.0 wt % of (A), alternatively from 90.0 to 98.7 wt % (e.g., 98.5 wt %) of (A). In some embodiments the comonomeric units derived from the alkenyl-functional hydrolyzable silane are from 1.0 to 2.0 wt % of (A), alternatively from 1.3 to 1.7 wt % (e.g., 1.5 wt %) of (A).

In some embodiments the comonomeric units derived from one or more olefinic hydrocarbons is 0 wt % of the (A) ethylene/(alkenyl-functional hydrolyzable silane)/(optional olefinic hydrocarbon) copolymer, i.e., (A) is free of the olefinic hydrocarbon units. In such embodiments the (A) is a bipolymer and is free of, for example, a (C₃-C₄₀)alpha-olefin, a diene, and a cyclic alkene. For example, the (A) may be an ethylene/vinyl trimethoxysilane (ethylene/VTMS) bipolymer consisting of 98.3 to 98.7 wt % ethylenic units and from 1.3 to 1.7 wt % of VTMS comonomeric units, alternatively 98.5 wt % ethylenic units and 1.5 wt % VTMS comonomeric units.

In other embodiments the comonomeric units derived from one or more olefinic hydrocarbons is from 1 to 40 wt % of (A), alternatively from 0 to 0.9 wt % of (A).

In some embodiments the (A) ethylene/(alkenyl-functional hydrolyzable silane)/(optional olefinic hydrocarbon) copolymer has a melt index (I₂, 190° C., 2.16 kg) from 1.0 to 2.0 g/10 min., alternatively from 1.2 to 1.7 g/10 min., alternatively from 1.4 to 1.6 g/10 min., alternatively 1.5 g/10 min.

In some embodiments the (A) Curable Copolymer is an ethylene/(vinyl trimethoxysilane) bipolymer having a silane content of 1.5 wt % based on total weight of (A) and a melt index (I₂, 19° C., 2.16 kg) of 1.5 g/10 min.

Copolymerization of alkenyl-functional hydrolyzable silane with ethylene and optionally olefinic hydrocarbon comonomers may be done in a high-pressure reactor that is used in the manufacture of ethylene homopolymers and copolymers with vinyl acetate and acrylates.

To remove all doubt, the (A) ethylene/(alkenyl-functional hydrolyzable silane)/(optional olefinic hydrocarbon) copolymer, and the formulation containing same and product made therefrom, is free of (does not contain) constituent units, or grafted groups, derived from an unsaturated carboxylic ester. For example, (A) is free of constituent units, or grafted groups, derived from an unsaturated carboxylic ester selected from an alkyl acrylate, alkyl methacrylate, and vinyl acetate.

The amount of the (A) ethylene/(alkenyl-functional hydrolyzable silane)/(optional olefinic hydrocarbon) copolymer in the moisture-curable semiconductive formulation may be from 43 to 68 wt % of the formulation. In some embodiments the (A) Curable Copolymer is from 48.0 to 63.0 wt %, alternatively from 48.5 to 53.9 wt %, alternatively from 51 to 56 wt %, alternatively from 52.0 to 63.0 wt %, alternatively from 48 to 49 wt %, alternatively from 53 to 54 wt %, alternatively from 62.5 to 63.2 wt % of the formulation. These wt % also apply to the amount of crosslinking reaction product thereof in the crosslinked semiconductive product.

Constituent (B) ethylene/(unsaturated carboxylic ester)(optional olefinic hydrocarbon) copolymer that is free of moisture curable groups such as groups derived from a hydrolyzable silane. When the (B) does not contain units derived from the olefinic hydrocarbon, the (B) is an ethylene/(unsaturated carboxylic ester) bipolymer that has constituent units consisting of ethylenic units and comonomeric units derived from the unsaturated carboxylic ester. When the (B) contains units derived from the olefinic hydrocarbon, the (B) is an ethylene/(unsaturated carboxylic ester)/olefinic hydrocarbon terpolymer that has constituent units consisting of ethylenic units, comonomeric units derived from the unsaturated carboxylic ester, and comonomeric units derived from the olefinic hydrocarbon.

The (B) Polar Copolymer may be a reactor copolymer of ethylene and the unsaturated carboxylic ester and, optionally, the optional olefinic hydrocarbon. Constituent (A) may be made by copolymerizing the unsaturated carboxylic ester with ethylene and, optionally, olefinic hydrocarbon monomer, in a high-pressure reactor. Suitable high pressure reactors are those used in the manufacture of ethylene homopolymers and ethylene copolymers with alkyl acrylates or vinyl acetate.

In some embodiments the (B) ethylene/(unsaturated carboxylic ester)(optional olefinic hydrocarbon) copolymer is free of constituent units derived from the olefinic hydrocarbon monomer.

In other embodiments the (B) ethylene/(unsaturated carboxylic ester)(optional olefinic hydrocarbon) copolymer contains one or more different types of constituent units derived from the olefinic hydrocarbon monomer. Each olefinic hydrocarbon monomer independently can be any hydrocarbon capable of being copolymerized with ethylene. In some embodiments there is only one type of olefinic hydrocarbon monomer. In some embodiments the olefinic hydrocarbon monomer is a (C₃-C₄₀)alpha-olefin. In some embodiments the (C₃-C₄₀)alpha-olefin is propylene; alternatively a (C₄-C₈)alpha-olefin, alternatively 1-butene or 1-hexene, alternatively 1-hexene or 1-octene, alternatively 1-butene, alternatively 1-hexene, alternatively 1-octene.

In some embodiments the (B) ethylene/(unsaturated carboxylic ester)(optional olefinic hydrocarbon) copolymer is the ethylene/ethyl acrylate (EEA) copolymer, alternatively the ethylene/butyl acrylate (EBA) copolymer.

The composition of the (B) ethylene/(unsaturated carboxylic ester)(optional olefinic hydrocarbon) copolymer is from 60 to 95 wt % of ethylenic units and from 5 to 40 wt % of comonomeric units derived from the unsaturated carboxylic ester, and from 0 to 40 wt % of comonomeric units derived from one or more olefinic hydrocarbons, all based on weight of (B). In some embodiments there is no other olefinic hydrocarbon and the (B) ethylene(unsaturated carboxylic ester)/(optional olefinic hydrocarbon) copolymer is an ethylene/(unsaturated carboxylic ester) bipolymer. In some embodiments the ethylene/(unsaturated carboxylic ester) bipolymer has an ethylenic content of from 65 to 90 wt %, alternatively from 75 to 85 wt %, and an unsaturated carboxylic ester comonomeric content of from 10 to 35 wt %, alternatively from 15 to 25 wt %, respectively. In some embodiments the ethylene/(unsaturated carboxylic ester) bipolymer has an ethylenic content of from 79 to 82 wt % and an unsaturated carboxylic ester comonomeric content of from 18 to 21 wt %. In some embodiments the ethylene/(unsaturated carboxylic ester) bipolymer is an ethylene/(ethyl acrylate) bipolymer that has an ethylenic content of from 79 to 82 wt % and an ethyl acrylate comonomeric content of from 18 to 21 wt %. In some embodiments any one of the foregoing bipolymers has a melt index of from 3 to 35 g/10 min., alternatively from 11 to 29 g/10 min., alternatively from 18 to 24 g/10 min., e.g., 21 g/10 min. (190° C., 2.16 kg). In some embodiments the ethylene/(unsaturated carboxylic ester) bipolymer is an ethylene/(ethyl acrylate) bipolymer that has an ethylenic content of 81 wt % and an ethyl acrylate comonomeric content of from 19 wt % and a melt index of 21 g/10 min. (190° C., 2.16 kg).

To remove all doubt, the (B) ethylene/(unsaturated carboxylic ester)(optional olefinic hydrocarbon) copolymer, and the formulation containing same and product made therefrom, is free of (does not contain) constituent units, or grafted groups, derived from an alkenyl-functional hydrolyzable silane. For example, (B) is free of constituent units, or grafted groups, derived from an alkenyl-functional hydrolyzable silane selected from a vinyl trialkoxysilane such as vinyl trimethylsilane or vinyl triethylsilane.

The amount of the (B) ethylene/(unsaturated carboxylic ester)(optional olefinic hydrocarbon) copolymer in the moisture-curable semiconductive formulation may be from 10.0 to 38 wt %, alternatively from 18 to 34 wt % of the total weight of the formulation. In some embodiments (B) is from 18.5 to 30.0 wt % of the formulation, alternatively from 19.0 to 19.9 wt % of the formulation, alternatively from 28 to 31 wt % (e.g., 29 wt %) of the formulation. These wt % also apply to the amount of (B) in the crosslinked semiconductive product.

Constituent (C) Carbon Black. Carbon black is a finely-divided form of paracrystalline carbon having a high surface area-to-volume ratio, but lower than that of activated carbon. Examples of carbon black are furnace carbon black, acetylene carbon black, conductive carbons (e.g., carbon fibers, carbon nanotubes, graphene, graphite, and expanded graphite platelets). The (C) Carbon Black used herein is electrically conductive. In some embodiments the (C) Carbon Black is a furnace carbon black.

In some embodiments the (C) Carbon Black has a Brunauer, Emmett and Teller (BET) total surface area BET-1 greater than 90.0 m²/g, alternatively less than 394 m²/g, alternatively greater than 90.0 m²/g and less than 394 m²/g, alternatively from 210 to 339 m²/g, alternatively from 218 to 259 m²/g, alternatively from 330 to 340 m²/g, all measured by a multipoint nitrogen adsorption method according to ASTM D6556-19a.

In some embodiments the (C) Carbon Black has an oil absorption number OAN-1 of greater than 170 mL/100 g, alternatively greater than 185 mL/100 g, alternatively from 186 to 340 mL/100 g, alternatively from 186 to 194 mL/100 g, alternatively as described in a preceding aspect, all measured according to ASTM D2414-19. In some such embodiments the (C) Carbon Black has any one of the foregoing OAN-1 values and a BET-1 surface area greater than 60.0 m²/g measured by a multipoint nitrogen adsorption method according to ASTM D6556-19a. In other such embodiments the (C) Carbon Black has any one of the foregoing OAN-1 values and a BET-1 total surface area greater than 90.0 m²/g, alternatively less than 394 m²/g, alternatively greater than 90.0 m²/g and less than 394 m²/g, alternatively from 210 to 339 m²/g, alternatively from 218 to 259 m²/g, alternatively from 330 to 340 m²/g, all measured by a multipoint nitrogen adsorption method according to ASTM D6556-19a.

Without being bound by theory, we believe that for a minimum loading of the (C) Carbon Black needed in the formulation and product made therefrom, in order to achieve a maximum acceptable volume resistivity measured at 130° C. (“VR(130° C.)”) can be described by one of two “best fit” mathematical equations. Which one of the equations is used depends upon whether the (C) Carbon Black has a BET total surface area BET-1 of from 65 to 230 m²/g or about 335 m²/g. For embodiments of the (C) Carbon Black having a BET total surface area BET-1 of from 65 to 230 m²/g and an oil absorption number OAN-1 >170 mL/100 g, the VR(130° C.) curve described by the “best fit equation” is: Ln (VR(130° C.))=−0.039*(wt %)²+1.115*(wt %)+5.684 with R²=0.9858. For embodiments of the (C) Carbon Black having a BET total surface area of about 335 m²/g and an OAN >170 mL/100 g, the VR(130° C.) curve described by the “best fit equation” is: Ln (VR(130° C.))=−0.039*(wt %)²+1.115*(wt %)+5.684 with R²=0.9858. The “wt %” is the loading of (C) based on total weight of the formulation or product, respectively.

The BET surface area of the (C) Carbon Black may be characterized by the BET total surface area (sometimes referred to herein as “BET-1”) only. Alternatively instead of the BET total surface area (e.g., BET-1), the BET surface area of the (C) Carbon Black may be characterized by a BET external surface area (sometimes referred to herein as “BET-2”), based on a statistical thickness surface area (STSA) method measured by a multipoint nitrogen adsorption method according to ASTM D6556-19a. In some embodiments the (C) Carbon Black has a BET external surface area BET-2 of greater than 90.0 m²/g, alternatively less than 394 m²/g, alternatively greater than 90.0 m²/g and less than 394 m²/g, alternatively from 210 to 339 m²/g, alternatively from 218 to 259 m²/g, alternatively from 330 to 340 m²/g, all measured by a multipoint nitrogen adsorption method according to ASTM D6556-19a. Alternatively, the BET surface area of the (C) Carbon Black may be characterized by both the BET total surface area value BET-1 and the BET external surface area value BET-2.

In some embodiments the (C) Carbon Black has a heating loss (primarily lost moisture content) of from 0 to 1.0 wt % measured at 125° C. according to ASTM D1509-18 (Standard Test Methods for Carbon Black—Heating Loss).

The amount of the (C) Carbon Black in the moisture-curable semiconductive formulation may be from 22 to 30.0 wt % of the formulation. These wt % also apply to the amount of (C) in the crosslinked semiconductive product.

In some embodiments the (C) Carbon Black is selected from the group consisting of: Carbon Black (C)-1: a carbon black having a BET total surface area BET-1 of 65 m²/g and an oil absorption number OAN-1 of 190 mL/100 g (e.g., commercially available as Ensaco 250G); Carbon Black (C)-2: a carbon black having a BET total surface area BET-1 of 800 m²/g and an oil absorption number OAN-1 of 310 to 360 mL/100 g (e.g., 338 mL/100 g; commercially available as Ketjen EC-300J); and Carbon Black (C)-3: a furnace carbon black having a BET total surface area BET-1 of 223 to 254 m²/g and an oil absorption number OAN-1 of 192 mL/100 g (e.g., commercially available as XC-72). In some embodiments the (C) Carbon Black is a furnace carbon black having a BET-1 of from 205 to 264 m²/g and an oil absorption number OAN-1 of 192 mL/100 g (e.g., the Carbon Black (C)-3).

In some embodiments the (C) Carbon Black is from 14.0 to 29.4 wt %, alternatively from 14.1 to 25.0 wt %, alternatively from 24.0 to 29.4 wt %, alternatively from 14.1 to 14.9 wt %, alternatively from 23.8 to 24.8 wt %, alternatively from 28.7 to 29.7 wt % of the formulation.

Ultra-low wettability carbon blacks, including those described in US 2021/0005344 A1, are excluded from the inventive embodiments described herein. Ultra-low wettability carbon blacks historically found use in electrodes of lithium-ion batteries. Lately ultra-low wettability carbon blacks have been used in semiconductive layers of power cables, such as described in US 2021/0002452 A1, US 2021/0002464 A1, and US 2021/0005344 A1. Examples are LITX 50 and LITX 200 Conductive Additives from Cabot Corporation. The ultra-low wettability nature of the excluded ultra-low-wettability carbon blacks may be characterized by a combination of oil absorption number (OAN), moisture uptake number, and surface wettability profile, test methods for all of which are described later. The ultra-low wettability carbon black has BET total surface area of from 35 to 190 m²/g, measured by BET Total Surface Area Test Method; an oil absorption number (OAN) from 115 to 180 mL/100 g, measured by Oil Absorption Number Test Method; and a water uptake of from 400 to 2400 parts per million (ppm, weight), measured by Moisture Uptake Test Method, described later. The ultra-low wettability carbon black also has a surface wettability profile characterized by wettability ≤0.0101 at surface coverage of 0.02, and wettability ≤0.0101 at surface coverage of 0.04, and wettability ≤0.0099 at surface coverage of 0.06, and wettability ≤0.0111 at surface coverage of 0.08, and wettability ≤0.0113 at surface coverage of 0.10, measured by inverse gas chromatography (IGC) according to Wettability Test Method, described later.

Constituent (X) at least one additive. The (X) at least one additive includes everything that is in the formulation and product other than constituents (A), (B), and (C) and the excluded materials. The total amount of the (X) at least one additive in the moisture-curable semiconductive formulation may be from 0 to 27 wt % of the formulation. When the total amount of (X) is 0 wt %, the formulation is free of the (X) at least one additive. When the total amount of (X) is greater than 0 wt %, i.e., from >0 wt % to 27 wt %, at least one additive is present in the formulation. In some embodiments the total amount of the (X) at least one additive is from 0.1 to 20.0 wt %, alternatively from 1.0 to 10.0 wt %, alternatively from 1.6 to 4.6 wt %, alternatively from 2.1 to 3.8 wt %, alternatively from 2.5 to 3.5 wt % of the formulation.

In some embodiments the (A) Curable Copolymer is from 48.0 to 63.0 wt % of the formulation; the (B) Polar Copolymer is from 19.0 to 29.4 wt % of the formulation; the (C) Carbon Black is from 14.0 to 29.4 wt % of the formulation; and the total amount of the (X) at least one additive is from 2.0 to 4.0 wt % of the formulation. These wt % also apply to the amount of (X) in the crosslinked semiconductive product.

Optional constituent (additive) (D) silanol condensation catalyst. In some aspects the (D) is not present in the formulation and/or product. The (D) silanol condensation catalyst may be an acid or a base, or a combination of any two or more thereof acids, any two or more bases, or any one or more acid and any one or more base.

Acids that can be used as the (D) silanol condensation catalyst include the tin carboxylates such as dibutyl tin dilaurate (DBTDL), dimethyl hydroxy tin oleate, dioctyl tin maleate, di-n-butyl tin maleate, dibutyl tin diacetate, dibutyl tin dioctoate, stannous acetate, and stannous octoate. Other useful acids are organo-metal compounds such as lead naphthenate, zinc caprylate and cobalt naphthenate. Other useful acids are phenols that that is not an antioxidant. Still other useful acids are sulfonic acids and blocked sulfonic acids. Combinations of two or more acids may be used, such as a combination of DBTDL and a sulfonic acid.

The sulfonic acid embodiment of (D) may be an alkylsulfonic acid, an arylsulfonic acid, an alkylarylsulfonic acid, or an arylalkylsulfonic acid. The sulfonic acid may be of formula RSO₃H wherein R is (C₁-C₁₀)alkyl, (C₆-C₁₀)aryl, a (C₁-C₁₀)alkyl-substituted (C₆-C₁₀)aryl, or a (C₆-C₁₀)aryl-substituted (C₁-C₁₀)alkyl. The sulfonic acid may be a hydrophobic sulfonic acid, which may be a sulfonic acid having a solubility in pH 7.0 distilled water of from 0 to less than 0.1 g/mL at 23° C. after 24 hours. The sulfonic acid may be methanesulfonic acid, benzenesulfonic acid, an alkylbenzenesulfonic acid (e.g., 4-methylbenzenesulfonic acid, dodecylbenzenesulfonic acid, or a dialkylbenzenesulfonic acid), naphthalenesulfonic acid, or an alkylnaphthalenesulfonic acid. The sulfonic acid may consist of carbon atoms, hydrogen atoms, one sulfur atom, and three oxygen atoms.

The blocked sulfonic acid embodiment of (D) is as defined in US 2016/0251535 A1 and is a compound that generates in situ the sulfonic acid of formula RSO₃H wherein R is as defined above upon heating thereof, optionally in the presence of moisture or an alcohol. Examples of the blocked sulfonic acid include amine-sulfonic acid salts and sulfonic acid alkyl esters. The blocked sulfonic acid may consist of carbon atoms, hydrogen atoms, one sulfur atom, and three oxygen atoms, and optionally a nitrogen atom.

Bases that can be used as the (D) silanol condensation catalyst include primary, secondary and tertiary amines.

In some embodiments the (D) silanol condensation catalyst comprises dibutyltin dilaurate (DBTDL).

In some embodiments the (D) silanol condensation catalyst comprises a catalyst blend of two or three different catalysts.

In some embodiments the total amount of the (D) silanol condensation catalyst in the inventive formulation and/or product is from 0.01 to 3 wt %, alternatively from 0.05 to 1.5 wt %, alternatively from 0.06 to 1.2 wt %, alternatively from 0.06 to 0.11 wt %.

Optional constituent (additive) (E) an antioxidant: an organic molecule that inhibits oxidation, or a collection of such molecules. The (E) antioxidant functions to provide antioxidizing properties to the moisture-curable semiconductive formulation and/or crosslinked polyolefin product. Examples of suitable (E) are bis(4-(1-methyl-1-phenylethyl)phenyl)amine (e.g., NAUGARD 445); 2,2′-methylene-bis(4-methyl-6-t-butylphenol) (e.g., VANOX MBPC); 2,2′-thiobis(2-t-butyl-5-methylphenol (CAS No. 90-66-4; 4,4′thiobis(2+butyl-5-methylphenol) (also known as 4,4′-thiobis(6-tert-butyl-m-cresol), CAS No. 96-69-5, commercially LOWINOX TBM-6); 2,2′-thiobis(6-t-butyl-4-methylphenol (CAS No. 90-66-4, commercially LOWINOX TBP-6); tris[(4-tert-butyl-3-hydroxy-2,6-dimethylphenyl)methyl]-1,3,5-triazine-2,4,6-trione (e.g., CYANOX 1790); pentaerythritol tetrakis(3-(3,5-bis(1,1-dimethylethyl)-4-hydroxyphenyl)propionate (e.g., IRGANOX 1010, CAS Number 6683-19-8); 3,5-bis(1,1-dimethylethyl)-4-hydroxybenzenepropanoic acid 2,2′-thiodiethanediyl ester (e.g., IRGANOX 1035, CAS Number 41484-35-9); distearyl thiodipropionate (“DSTDP”); dilauryl thiodipropionate (e.g., IRGANOX PS 800); stearyl 3-(3,5-di-t-butyl-4-hydroxyphenyl)propionate (e.g., IRGANOX 1076); 2,4-bis(dodecylthiomethyl)-6-methylphenol (IRGANOX 1726); 4,6-bis(octylthiomethyl)-o-cresol (e.g. IRGANOX 1520); and 2′,3-bis[[3-[3,5-di-tert-butyl-4-hydroxyphenyl]propionyl]] propionohydrazide (IRGANOX 1024). In some embodiments (E) is 4,4thiobis(2-t-butyl-5-nethylphenol) (also known as 4,4′-thiobis(6-tert-butyl-m-cresol); 2,2′-thiobis(6-t-butyl-4-methylphenol; tris[(4-tert-butyl-3-hydroxy-2,6-dimethylphenyl)methyl]-1,3,5-triazine-2,4,6-trione; distearyl thiodipropionate; or dilauryl thiodipropionate; or a combination of any two or more thereof. The combination may be tris[(4-tert-butyl-3-hydroxy-2,6-dimethylphenyl)methyl]-1,3,5-triazine-2,4,6-trione and distearyl thiodipropionate. In some embodiments the (E) is pentaerythritol tetrakis(3-(3,5-bis(1,1-dimethylethyl)-4-hydroxyphenyl)propionate; 2′,3-bis[[3-[3,5-di-tert-butyl-4-hydroxyphenyl]propionyl]] propionohydrazide; or a combination thereof. In some embodiments the moisture-curable semiconductive formulation and/or crosslinked polyolefin product is free of (E). When present, the total amount of the (E) antioxidant may be from 0.01 to 8 wt %, alternatively 0.05 to 7 wt %, alternatively 3 to 6 wt % of the total weight of the moisture-curable semiconductive formulation and/or crosslinked polyolefin product. In some embodiments the formulation and product independently comprise from 2.7 to 3.9 wt % of pentaerythritol tetrakis(3-(3,5-bis(1,1-dimethylethyl)-4-hydroxyphenyl)propionate and from 1.3 to 2.0 wt % of 2′,3-bis[[3-[3,5-di-tert-butyl-4-hydroxyphenyl]propionyl]] propionohydrazide.

Optional constituent (additive) (F) a carrier resin. In the method of making the moisture-curable semiconductive formulation, the (C) Carbon Black and/or one or more of the (X) at least one additive, such as the (D) silanol condensation catalyst, independently may be provided to constituents (A) and (B) in the form of a masterbatch comprising the (F) carrier resin having dispersed therein the (C) Carbon Black or the (X) at least one additive, such as the (D) silanol condensation catalyst. For example, a carbon black masterbatch may contain from >0 wt % to ≤5 wt % of the (C) Carbon Black dispersed in from 95 wt % to <100 wt % of the (F) carrier resin, based on total weight of the carbon black masterbatch. Likewise, a catalyst masterbatch may contain from 5 to 20 wt % of the (D) silanol condensation catalyst dispersed in from 80 wt % to <95 wt % of the (F) carrier resin, based on total weight of the catalyst masterbatch. In some embodiments the (F) carrier resin is that is a poly(1-butene-co-ethylene) copolymer. In some embodiments of the method of making, (F) and (D) are provided to constituents (A) and (B) in the form of the catalyst masterbatch and/or (F) and (C) are provided to constituents (A) and (B) in the form of the carbon black masterbatch. The amount of the catalyst masterbatch used to make the formulation may be from 2.5 to 5.0 wt %, alternatively 2.6 to 4.6 wt % of the total weight of the formulation. In other embodiments the (F) carrier resin is not present in the formulation and/or product made therefrom.

In some embodiments the (F) carrier resin comprises a blend of two or more different carrier resins. For example the (F) carrier resin may be a blend consisting of an ethylene/1-butene copolymer and a polyethylene homopolymer, such as a blend consisting of 85 to 90 wt % of the ethylene/1-butene copolymer and from 10 to 15 wt % of the polyethylene homopolymer.

Optional constituent (additive) (G) a metal deactivator. The (G) metal deactivator functions to chelate with transition metal ions (e.g., residues of olefin polymerization catalysts) to render them inactive as oxidation catalysts. Examples of (G) are N′1,N′12-bis(2-hydroxybenzoyl)dodecanedihydrazide (CAS no. 63245-38-5), and oxalyl bis(benzylidene hydrazide) (OABH). In some embodiments (G) is not present in the inventive formulation and/or product. In some embodiments (G) is present in the inventive formulation and/or product at a concentration from 0.001 to 0.2 wt %, alternatively 0.01 to 0.15 wt %, alternatively 0.01 to 0.10 wt %, all based on total weight thereof.

Optional constituent (additive) (H) moisture scavenger. The (H) moisture scavenger functions to inhibit premature moisture curing of the moisture-curable semiconductive formulation, wherein premature moisture curing would result from premature or prolonged exposure of the moisture-curable semiconductive formulation to ambient air. Examples of (H) are octyltriethoxysilane and octyltrimethoxysilane. In some embodiments (H) is not present in the inventive formulation and/or product. In some embodiments (H) is present in the inventive formulation and/or product at a concentration from 0.001 to 0.2 wt %, alternatively 0.01 to 0.15 wt %, alternatively 0.01 to 0.10 wt %, all based on total weight thereof. When (H) is used, it may be pre-mixed with the (A) ethylene/(alkenyl-functional hydrolyzable silane)/(optional olefinic hydrocarbon) copolymer prior to being combined with the (B) Polar Copolymer and (C) Carbon Black.

Other optional constituents. In some embodiments the formulation and product made therefrom does not contain any other optional constituents. In some embodiments the formulation and/or product further contains at least one other optional constituent (additive) that is a lubricant, mineral oil, an anti-blocking agent, a treeing retardant (water treeing and/or electrical treeing retardant), a scorch retardant, or a processing aid.

Moisture-cured semiconductive product. A reaction product of moisture curing the moisture-curable semiconductive formulation. The product differs from the formulation in composition and properties. Molecules of the (A) ethylene/(alkenyl-functional hydrolyzable silane)/(optional olefinic hydrocarbon) copolymer in the formulation have been crosslinked to each other in the product such that the product contains a network structure composed of (x-A) crosslinked ethylene/(alkenyl-functional hydrolyzable silane)/(optional olefinic hydrocarbon) copolymer. The crosslinking is achieved by the moisture curing of the formulation. The exact extent of crosslinking in the product may vary depending upon particular result-effective circumstances of any given embodiment thereof. Such result-effective circumstances may comprise the composition of the (A) Curable Copolymer, the loading of the (A) Curable Copolymer in the formulation, and the moisture curing conditions used. In some embodiments the extent of crosslinking is such that the product has a gel content of greater than 60 wt %.

Any optional constituent may be useful for imparting at least one characteristic or property to the inventive formulation and/or product in need thereof. The characteristic or property may be useful for improving performance of the inventive formulation and/or product in operations or applications wherein the inventive formulation and/or product is exposed to elevated operating temperature. Such operations or applications include melt mixing, extrusion, molding, hot water pipe, and insulation layer of an electrical power cable.

In some embodiments the phrase “consisting essentially of” also means that the moisture-curable semiconductive formulation, and the crosslinked semiconductive product made therefrom, are free of all of the foregoing excluded materials and free of all of the foregoing excluded features.

The following apply unless indicated otherwise. Alternatively precedes a distinct embodiment. ASTM means the standards organization, ASTM International, West Conshohocken, Pennsylvania, USA. IEC means the standards organization, International Electrotechnical Commission, Geneva, Switzerland. Any comparative example is used for illustration purposes only and shall not be prior art. A blend of two or more polymers may be a post-reactor blend (e.g., made by mixing a melt of a first polymer with a melt of a second polymer in an extruder) or a reactor blend (made by polymerizing to make a first polymer in the presence of a second polymer or by making both polymers simultaneously using a bimodal catalyst system). Free of or lacks means a complete absence of; alternatively not detectable. IUPAC is International Union of Pure and Applied Chemistry (IUPAC Secretariat, Research Triangle Park, North Carolina, USA). May confers a permitted choice, not an imperative. Operative means functionally capable or effective. Optional(ly) means is absent (or excluded), alternatively is present (or included). PPM are weight based. Properties are measured using a standard test method and conditions for the measuring (e.g., viscosity: 23° C. and 101.3 kPa). Ranges include endpoints, subranges, and whole and/or fractional values subsumed therein, except a range of integers does not include fractional values. Room temperature is 23° C.±1° C. Substituted when referring to a compound means having, in place of a hydrogen atom a substituent group.

General Method of Making an Masterbatch of (C) Carbon Black, (D) silanol condensation catalyst, or (X) additive: melt-mix the (F) carrier resin with one of ingredients (C), (D), or (X) at a mixing speed of 30 to 50 rotations per minute (rpm) for 20 minutes at 160° C. using a C. W. Brabender prep-mixer to make the masterbatch of (F) and either (C), (D), or (X), respectively. These conditions may be adjusted to ensure proper melt-mixing by, for example, using a higher temperature (e.g., 200° C.) or higher mixing speed (e.g., 65 rpm), and/or longer mixing time (e.g., 40 minutes).

General Method of Making the Moisture-Curable Semiconductive Formulation: prepare an embodiment of the formulation consisting essentially of the (A) Curable Copolymer, (B) Polar Copolymer, and (C) Carbon Black, and optionally the (X) at least one additive, as follows. Add the ingredients (A), (B), (C), and, optionally the (X) at least one additive into a Brabender mixing bowl, melt-mix them together to give a melt of the formulation, and then granulate and extrude the melt of the formulation at a temperature that is about 20° C. higher (e.g., 145° C.) than the melting temperature of (A) Curable Copolymer or (B) Polar Copolymer, whichever melting temperature is higher. Use a screw speed of 25 rpm to make the formulation in the form of a melt strand. The compounding conditions may be adjusted to ensure proper extruding and stranding, such as using a higher temperature (e.g., 160° C.) or higher mixing speed (e.g., 40 rpm), and/or longer mixing time. Optionally if pellets are desired, then feed the melt strand into a Brabender Pelletizer to give the moisture-curable semiconductive formulation in the form of pellets. In some embodiments the (X) at least one is included in the formulation. In some embodiments the (X) at least one additive comprises the (D) silanol condensation catalyst and (E) antioxidant (at least one), which may be added directly to the hopper. In some embodiments the formulation is free of the (F) carrier resin. In other embodiments the (C) Carbon Black is delivered to the hopper in the form of a carbon black masterbatch comprising from 25 to 50 wt % of (C) Carbon Black and from 50 to 75 wt % of (F) carrier resin. In some embodiments the (X) at least one additive is delivered to the hopper in the form of an additive masterbatch comprising from 5 to 20 wt % of the (X) at least one additive and from 80 to 95 wt % of the (F) carrier resin. The (X) at least one additive in the additive masterbatch may be the (D) silanol condensation catalyst.

Compression Molded Plaque Preparation Method 1: place a virgin sample of a material in a mold, and press in a Grenerd hydraulic press as follows: preheat the press to 150° C.; then heat sample in mold without pressure for 3 minutes to give heated sample; press heated sample at 0.689 megapascals (MPa, 100 pounds per square inch (psi)) pressure for 3 minutes and then press at 17.2 MPa (2500 psi) pressure for 3 minutes; quench the mold and keep it at 40° C. for 3 minutes at 0.689 MPa pressure to give compression molded plaque of the sample.

Compression Molded Plaque Preparation Method 2: The soaked pellets made by the Moisture-curable semiconductive formulation Sample Preparation Method were compressed into a plaque through a double compression procedure. The first compression was conducted at 120° C. for 3 minutes under 3.45 megapascals (MPa, 500 psi), plus 3 minutes under 172 MPa (25,000 psi). In the second step, the plaque was cut into quarters and re-compressed at 120° C. for 3 minutes at 3.45 MPa (500 psi), plus 15 minutes at 1800 to 185° C., or at 2100 to 215° C., both under 172 MPa (25,000 psi) to give a second plaque with thickness of 1.27 millimeters (mm, 50 mils).

Brunauer, Emmett and Teller (BET) Total Surface Area Test Method: measured by a multipoint nitrogen adsorption method according to ASTM D6556-19a (Standard Test Method for Carbon Black—Total and External Surface Area by Nitrogen Adsorption), and the value expressed as square meters of total surface area per gram of material (m²/g). Perform BET total surface area analysis using a Micromeritics Accelerated Surface Area & Porosimetry instrument (ASAP 2420). Out-gas samples at 250° C. while under vacuum prior to analysis. The instrument employs a static (volumetric) method of dosing samples and measures the quantity of gas (N₂) that can be physically adsorbed (physisorbed) on a solid at liquid nitrogen temperature. For a multi-point BET measurement measure the volume of nitrogen uptake at pre-selected relative pressure points at constant temperature. The relative pressure is the ratio of the applied nitrogen pressure to the vapor pressure of nitrogen at analysis temperature of −196° C. A BET external surface area (sometimes referred to herein as “BET-2”), based on a statistical thickness surface area (STSA) method, may also be measured by a multipoint nitrogen adsorption method according to ASTM D6556-19a.

Gel Content Test Method: measured according to ASTM D2765.

Heating Loss Test Method: heating loss (primarily lost moisture content) of carbon black is measured at 125° C. according to ASTM D1509-18 (Standard Test Methods for Carbon Black—Heating Loss), and expressed in wt %.

Elongation Test Method. Prepared test specimens from extruded tapes, which were prepared according to the method described herein, or from coated wires, which were prepared according to method described herein. Test the specimens using ASTM D638-10, Standard Test Method for Tensile Properties of Plastics. Aged the test specimens in an air circulating oven at 121° C. After 7 days of aging, cool and test the aged/cooled specimens using ASTMD638-10. The percent elongation is equal to the final length divided by initial length.

Hydrolyzable Silane Content Test Method: hydrolyzable silane content in the (A) Curable Copolymer is determined as the weight percent of alkenyl-functional hydrolyzable silane comonomer used in copolymerization with ethylene and, optionally, olefinic hydrocarbon comonomer, based on total weight of the (A) Curable Copolymer made by the copolymerization. Alternatively, measured using carbon-13 nuclear magnetic resonance (¹³C-NMR). Hydrolyzable silane content in the moisture-curable semiconductive formulation is determined by multiplying the hydrolyzable silane content in the (A) Curable Copolymer times the loading of the (A) Curable Copolymer in wt % of the total weight of the formulation.

Low-Temperature Brittleness Test Method: measured according to ASTM D746.

Melt Index Test Method (“12”): for non-polar ethylene-based polymer is measured according to ASTM D1238-04, Standard Test Method for Melt Flow Rates of Thermoplastics by Extrusion Platometer, using conditions of 190° C./2.16 kilograms (kg), formerly known as “Condition E” and also known as 12. Report results in units of grams eluted per 10 minutes (g/10 min.).

Moisture Curing Test Method. Moisture curing and Curing rate measurement Test Method. The specimen (e.g., extruded tape, coated wire, or other manufactured article) was cured by immersing it in a water bath at 90° C. for from 3 to 16 hours. Without being bound by theory, when the specimen is an extruded tape prepared according to the method described below, after 3 hours at 90° C., it is believed that the amount of crosslinking in the extruded tape has reached a steady state value. Different types of specimens may require a slightly shorter or slightly longer immersion time periods to reach a steady-state crosslinking, depending upon the thickness or bulk of the specimen being cured. It is believed that 16 hours is a sufficient period of time for all the different specimens to reach a steady-state crosslinking.

Moisture Uptake Test Method: measure moisture uptake of carbon blacks by drying a carbon black sample in a vacuum oven at 100° C. overnight, measuring the weight of the dried carbon black sample, placing the dried carbon black sample inside a chamber with well-controlled 80% relative humidity (RH) and temperature 24° C. for 24 hours to give a humidified carbon black sample, weighing the humidified carbon black sample, and calculating the amount of moisture uptake in weight parts per million using the following equation: amount moisture uptake=(weight of humidified CB sample−weight of dried CB sample) divided by weight of dried CB sample.

Oil Absorption Number (OAN) Test Method: measured according to ASTM D2414-19 (Standard Test Method for Carbon Black—Oil Absorption Number (OAN)), and expressed as milliliters of oil absorbed per 100 grams of absorbent material (e.g., carbon black) (mL/100 g). Use Procedure A with dibutyl phthalate (DBP).

Scorch Lumps on Wire Insulation Test Method: the exterior surface of a coated wire was visually inspected for presence of lumps or irregularities in the surface.

Tape Preparation Method: extruded tapes were made from granules of test material. The granules were melted and extruded using a system comprising a 1.91 cm (¾ inch), 25:1 L/D Brabender extruder and a “pineapple” Maddock mixing screw through a 5.1 cm (2 inches) wide×1.91 mm (75 mils) thick tape die. For preparing tapes, the granules were dry blended with a catalyst masterbatch then extruded on the above system. In both preparation methods, the following extruder barrel temperature profile was used: 160° C., 170° C., 180° C., and 180° C. with a die temperature of 185° C.

Surface Roughness Test Method: this method measures roughness of surfaces of crosslinked (water-bath cured) extruded tapes prepared according to the Tape Preparation Method or roughness of surfaces of crosslinked (water bath cured) coated wires prepared according to the Coated Wire Preparation Method. The surface roughness is reported in micrometers (μm) (or microinches) as a value, Rₐ, which is the arithmetic average deviation above and below a center line of a stylus passing over the surface of the tape or coated wire.

Volume Resistivity Test Method: Measure resistivity of samples with low resistivity (<10⁸ Ohm-cm (Ω·cm)) using a Keithley 2700 Integra Series digital multimeter with 2-point probe. Apply silver paint (conductive silver #4817N) to minimize contact resistance between the samples and electrodes, wherein the sample is a compression molded plaque sample prepared by the Compression Molded Plaque Preparation Method with thickness of 1.905 to 1.203 mm (75 mils to 80 mils), length of 101.6 mm, and width of 50.8 mm. The temperature of the sample is 90° C. or 130° C. Measure resistivity of samples with high resistivity (>10⁸ Ω·cm) using a Keithley Model 6517B electrometer coupled with a Model 8009 resistivity test chamber using circular disk samples, wherein the sample is a circular disk prepared as a compression molded plaque sample prepared by the Compression Molded Plaque Preparation Method with thickness of 1.905 to 1.203 mm (75 mils to 80 mils) and a diameter of 63.5 mm.

Wafer Boil Test Method: A wafer is made from an extruded semiconductive formulation by removing a cross-section of an extruded semiconductive material layer from the conductor to give a wafer in the form of a ring of the semiconductive material, the wafer having a thickness of from 0.635 to 0.762 mm (25 to 30 mils). The wafer was immersed in boiling decahydronapthalene reagent as specified in ASTM D2765 and kept there for 5 hours. The wafer was then removed and visually examined at 15× magnification for wafer continuity. Passing this test means the wafer ring maintained its continuity, i.e., was not broken.

Wettability Test Method: using inverse gas chromatography (IGC) method with an IGC Surface Energy Analyzer instrument and SEA Analysis Software, both from Surface Measurement Systems, Ltd., Allentown, Pennsylvania, USA. The total surface energy (γ(Total)) of a material is the summation of two components, the dispersive component (γ(Dispersive)) and the polar component (γ(Polar)): γ(Total)=γ(Polar)+γ(Dispersive). Measure the γ(Dispersive) component with four alkane gas probes: decane, nonane, octane, and heptane, and determine γ(Dispersive) with the method of Dorris and Gray (see below). Measure the γ(Polar) component with two polar gas probes: ethyl acetate and dichloromethane, and analyze γ(Polar) based on the van Oss approach with the Della Volpe scale (D. J. Burnett et al., AAPS PharmSciTech, 2010, 13, 1511-1517; G. M. Dorris et al. J. Colloid Interface Sci. 1980, 23, 45-60; C. Della Volpe et al., J Colloid Interface Sci, 1997, 195, 121-136). Pack approximately 10 to 20 milligrams (mg) of amounts of a test sample of neat carbon black into individual silanized glass column (300 mm long by 4 mm inner diameter). Precondition the carbon black-packed columns for 2 hours at 100° C. and 0% relative humidity with helium carrier gas to normalize samples. Perform measurements with 10 standard cubic centimeter per minute (sccm) total flow rate of helium, and use methane for dead volume corrections. Measure components at 100° C. and 0% relative humidity. The surface energy of carbon black is measured as a function of surface coverage, n/nₘ, where n is the sorbed amount of gas probe, nₘ is the monolayer capacity of carbon black. The distribution of surface energy as a function of surface coverage reveals the heterogeneity of the carbon black surface.

Materials used in the comparative and/or inventive examples follow.

Ultra-low wettability carbon black number 1 (“ULW-Carbon Black-1”): BET total surface area of 56 m²/g, measured by the BET Total Surface Area Test Method; an OAN of 125 to 145 mL/100 g, measured by ASTM D2414-04; moisture uptake 520 ppm, measured by the Moisture Uptake Test Method; and a surface wettability profile characterized by wettability=0.0014 at surface coverage of 0.02, and wettability=0.0039 at surface coverage of 0.04, and wettability=0.0051 at surface coverage of 0.06, and wettability=0.0061 at surface coverage of 0.08, and wettability=0.0069 at surface coverage of 0.10. Obtained as LITX 50 from Cabot Corporation.

(A) Curable copolymer number 1 (“Curable Copolymer (A)-1”): an ethylene/(vinyl trimethoxysilane) bipolymer having an ethylenic content of 98.5 wt % and a silane comonomeric content of 1.5 wt % based on total weight of (A)-1 and a melt index (I₂, 190° C., 2.16 kg) of 1.5 g/10 min. Available as DFDA-5451 NT from The Dow Chemical Company. Also available as a pre-blend with Moisture Scavenger (H)-1 in DFDB-5451 NT.

(B) Polar Copolymer number 1 (“Polar Copolymer (B)-1”): an ethylene/ethyl acrylate (EEA) bipolymer having an ethylenic content of 81 wt % and an ethyl acrylate content of 19 wt % wt % and a melt index (I₂, 190° C., 2.16 kg) of 21 g/10 min.

(B) Polar Copolymer number 2 (“Polar Copolymer (B)-2”): an ethylene/vinyl acetate (EVA) copolymer having an ethylenic content of 72 wt % and a vinyl acetate content of 28 wt % and a melt index (I₂, 190° C., 2.16 kg) of 6 g/10 min.

(C) Carbon black number 1 (“Carbon Black (C)-1”): a carbon black having a BET total surface area (“BET-1”) of 65 m²/g and an OAN of 190 mL/100 g. Commercially available as Ensaco 250G.

(C) Carbon black number 2 (“Carbon Black (C)-2”): a carbon black having a BET total surface area (“BET-1”) of 800 m²/g and an OAN of 335 mL/100 g. Commercially available as Ketjen EC-300J.

(C) Carbon black number 3 (“Carbon Black (C)-3”): a furnace carbon black having a BET total surface area (“BET-1”) of 223 to 254 m²/g and an OAN of 192 mL/100 g. Commercially available as XC-72.

(D) Silanol condensation catalyst number 1 (“Catalyst (D)-1”): dibutyltin dilaurate (DBTDL).

(E) Antioxidant number 1 (“Antioxidant (E)-1”): pentaerythritol tetrakis(3-(3,5-bis(1,1-dimethylethyl)-4-hydroxyphenyl)propionate, obtained as IRGANOX 1010.

(E) Antioxidant number 2 (“Antioxidant (E)-2”): 2′,3-bis[[3-[3,5-di-tert-butyl-4-hydroxyphenyl]propionyl]] propionohydrazide, obtained as IRGANOX 1024.

(F) Carrier resin number 1 (“Carrier Resin (F)-1”): a blend consisting of 85 to 90 wt % of an ethylene/1-butene copolymer and 10 to 15 wt % of a polyethylene homopolymer.

(H) Moisture Scavenger number 1 (“Moisture Scavenger (H)-1”): octyltriethoxysilane.

Catalyst Masterbatch number 1 (“Catalyst MB-1”): the Catalyst (D)-1 and the Carrier Resin (F)-1 were provided in the form of a catalyst masterbatch to the other ingredients during the making of the comparative and inventive examples of moisture-curable semiconductive formulations. In the examples from 2.6 to 4.2 wt % of the Catalyst MB-1 is used and from 96.6 to 97.4 wt % of the other ingredients are used, wherein the other ingredients include Curable Copolymer (A)-1, Polar Copolymer (B)-1 or Polar Copolymer (B)-2, and one Carbon Black selected from (C)-1, (C)-2, and (C)-3. Catalyst MB-1 is a blend of 2.6 wt % Catalyst (D)-1 and 92.4 wt % of the Carrier Resin (F)-1 and a total of 5.0 wt % of antioxidants (E)-1 and (E)-2.

Method of Making the Comparative and Inventive Examples: all of the constituents used in any one of the formulations of the Comparative Examples and Inventive Examples described herein were mixed together in a batch mixer at 145° C. (a target temperature that is about 20° C. higher than the melting point of the Curable Polymer (A)-1 for 5 minutes at 40 rotations per minute (rpm) to give moisture-curable semiconductive formulation containing constituents indicated in Tables 1 and 2, respectively. After mixing, the sample was granulated to give the comparative formulation or the inventive moisture-curable semiconductive formulation, as the case may be, in the form of granules.

Extruded tapes were made as follows. Initial embodiments of the moisture-curable semiconductive formulations were made from ingredients (A)-1, (B)-1, and one of (C)-1 to (C)-3 by mixing the ingredients together on a Brabender compounder at melt temperature less than 200° C. to give the initial embodiments, which were free of (D)-1 and (F)-1. The initial embodiments were granulated. Each granulated material was separately combined with an amount of the Catalyst MB-1 to give second embodiments of the moisture-curable semiconductive formulations. Tapes were made by extruding the second embodiments using a ¾ inch Brabender extruder using a “pineapple” Maddock mixing screw to make tapes having a thickness of 1.9 millimeters (mm, 75 mils). The tapes were cured in a 90° C. water bath for 3 hours. The following tests were performed using the tapes: volume resistivity at 90° and 130° C., surface roughness, gel content, low-temperature brittleness, elongation.

Coated wires were made as follows. Initial embodiments of the moisture-curable semiconductive formulations were made from ingredients (A)-1, (B)-1, and one of (C)-1 to (C)-3 by mixing the ingredients together on a Brabender compounder at melt temperature less than 200° C. to give the initial embodiments, which were free of (D)-1 and (F)-1. The initial embodiments were granulated. Each granulated material was separately combined with an amount of the Catalyst MB-1 to give second embodiments of the moisture-curable semiconductive formulations. Semiconductive layers of the second embodiments were extruded on to a 14 American Wire Gauge (awg) wire. The semiconductive layers had a wall thickness of 0.76 mm (30 mils). The extrusion conditions included a melt temperature around 180° to 190° C. (using PE/pineapple/Maddock screw). The wire samples were cured overnight for at least 12 hours (e.g., from 12 to 24 hours) in a 90° C. water bath to make crosslinked semiconductive products in the form of embodiments of the coated conductor. The following properties were tested using the wire insulation of the coated conductors: presence of absence of scorch lumps; and wafer boil test.

Comparative Examples A and B (CEA and CEB) based on information from U.S. Pat. No. 6,080,810 are based on ethylene/hydrolyzable silane/polar comonomer terpolymers and various conventional carbon blacks show that when the carbon black is a furnace black having a BET total surface areas of from 83 to 150 m²/g (CEA) or is a Ketjen black having a BET total surface area of from 950 to 1250 m²/g (CEB), tapes made therefrom are too rough, i.e., the tapes have insufficient tape smoothness.

Comparative Examples 1 to 4 (CE1 to CE4): comparative formulations were prepared and tested according to the above described methods. See results described below in Table 1. CE1 was made by making an initial formulation that had all ingredients except the ingredients contributed by the Catalyst MB-1, and then mixing together 97.4 wt % of the initial formulation and 2.6 wt % of the Catalyst MB-1. CE2 was made by making an initial formulation that had all ingredients except the ingredients contributed by the Catalyst MB-1, and then mixing together 96.8 wt % of the initial formulation and 3.2 wt % of the Catalyst MB-1. CE3 was made by making an initial formulation that had all ingredients except the ingredients contributed by the Catalyst MB-1, and then mixing together 95.8 wt % of the initial formulation and 4.2 wt % of the Catalyst MB-1. CE4 was made by making an initial formulation that had all ingredients except the ingredients contributed by the Catalyst MB-1, and then mixing together 97.4 wt % of the initial formulation and 2.6 wt % of the Catalyst MB-1.

TABLE 1
Final Compositions (wt %) and Properties of CE1 to CE4.

| Ex. No. | CE1 | CE2 | CE3 | CE4 |
|---|---|---|---|---|
| Curable Copolymer (A)-1, wt % | 48.7 | 58.1 | 76.6 | 48.7 |
| Polar Copolymer (B)-1, wt % | 29.2 | 28.9 | 0 | 19.5 |
| Carbon Black (C)-1, wt % | 19.5 | 0 | 0 | 0 |
| (BET-1 65 m²/g; OAN-1 190 mL/100 g) | | | | |
| Carbon Black (C)-2, wt % | 0 | 0 | 0 | 0 |
| (BET-1 800 m²/g; OAN-1 338 mL/100 g) | | | | |
| Carbon Black (C)-3, wt % | 0 | 0 | 0 | 0 |
| (BET-1 223-254 m²/g; OAN-1 192 mL/100 g) | | | | |
| ULW-Carbon Black-1 | 0 | 9.7 | 19.2 | 29.2 |
| (BET-1 56 m²/g; OAN-1 125-145 mL/100 g) | | | | |
| Catalyst (D)-1, wt % | 0.1 | 0.1 | 0.1 | 0.1 |
| Antioxidant (E)-1 , wt % | <0.1 | <0.2 | <0.2 | <0.1 |
| Antioxidant (E)-2 , wt % | <0.1 | <0.1 | <0.2 | <0.1 |
| Carrier Resin (F)-1, wt % | 2.4 | 3.0 | 3.0 | 2/4 |
| Total Amount, wt % | 100 | 100 | 100 | 100 |
| Gel Content (wt %) | 33 | 48 | 68 | 58 |
| Volume Resistivity at 90° C. (Ohm-cm) | 767,179 | Overflow | Overflow | 5 |
| Volume Resistivity at 130° C. (Ohm-cm) | Overflow | Overflow | Overflow | 12 |
| Elongation (after aging 7 d, 121° C.), % | 153 | 209 | 156 | N/m |
| (extruded tape) | | | | |
| Elongation (after aging 7 d, 121° C.), % | N/m | N/m | N/m | 122 |
| (coated wire) | | | | |
| Brittleness Failure Temperature, ° C. | ≤−30° C. | ≤−30° C. | ≤−30° C. | ≤−30° C. |
| Surface Roughness, Rₐ, μm | 2.08 | 1.45 | 0.264 | N/m |
| (crosslinked extruded tape) | | | | |
| Surface Roughness, Rₐ, μm | N/m | N/m | N/m | 0.589 |
| (crosslinked coated wire) | | | | |
| Presence of Scorch Lumps (yes/no) | N/m* | N/m | N/m | No |
| Wafer Boil Test (pass/fail) | N/m | N/m | N/m | Pass |

*N/m means not measured.

Inventive Examples 1 to 5 (IE1 to IE5): inventive moisture-curable semiconductive formulations were prepared and tested according to the above described methods. See results described below in Table 2. IE1 was made by making an initial formulation that had all ingredients except the ingredients contributed by the Catalyst MB-1, and then mixing together 97.1 wt % of the initial formulation and 2.9 wt % of the Catalyst MB-1. IE2 was made by making an initial formulation that had all ingredients except the ingredients contributed by the Catalyst MB-1, and then mixing together 97.4 wt % of the initial formulation and 2.6 wt % of the Catalyst MB-1. IE3 was made by making an initial formulation that had all ingredients except the ingredients contributed by the Catalyst MB-1, and then mixing together 96.6 wt % of the initial formulation and 3.4 wt % of the Catalyst MB-1. IE4 was made by making an initial formulation that had all ingredients except the ingredients contributed by the Catalyst MB-1, and then mixing together 97.1 wt % of the initial formulation and 2.9 wt % of the Catalyst MB-1. IE5 was made by making an initial formulation that had all ingredients except the ingredients contributed by the Catalyst MB-1, and then mixing together 97.4 wt % of the initial formulation and 2.6 wt % of the Catalyst MB-1.

TABLE 2
Final Compositions (wt %) and Properties of IE1 to IE5.

| Ex. No. | IE1 | IE2 | IE3 | IE4 | IE5 |
|---|---|---|---|---|---|
| Curable Copolymer (A)-1, wt % | 53.4 | 48.7 | 62.8 | 53.4 | 48.21 |
| Polar Copolymer (B)-1, wt % | 29.1 | 19.5 | 19.3 | 19.4 | 19.5 |
| Carbon Black (C)-1, wt % | 0 | 0 | 0 | 24.3 | 0 |
| (BET-1 65 m²/g; OAN-1 190 mL/100 g) | | | | | |
| Carbon Black (C)-2, wt % | 14.5 | 0 | 14.5 | 0 | 0 |
| (BET-1 800 m²/g; OAN-1 335 mL/100 g) | | | | | |
| Carbon Black (C)-3, wt % | 0 | 29.2 | 0 | 0 | 29.2 |
| (BET-1 223-254 m²/g; OAN-1 192 mL/100 g) | | | | | |
| ULW-Carbon Black-1 | 0 | 0 | 0 | 0 | 0 |
| (BET-1 56 m²/g; OAN-1 125-145 mL/100 g) | | | | | |
| Catalyst (D)-1, wt % | 0.08 | 0.07 | 0.09 | 0.08 | 0.07 |
| Antioxidant (E)-1 , wt % | <0.1 | <0.1 | <0.2 | <0.1 | <0.1 |
| Antioxidant (E)-2 , wt % | <0.1 | <0.1 | <0.1 | <0.1 | <0.1 |
| Carrier Resin (F)-1, wt % | 2.5** (2.7) | 2.4 | 3.2 | 2.7 | 2.4 |
| Moisture Scavenger (H)-1, wt % | 0 | 0 | 0 | 0 | 0.49 |
| Total Amount, wt % | 100 | 100 | 100 | 100 | 100 |
| Gel Content (wt %) | 44 | 44 | N/m | 59 | 57 |
| Volume Resistivity at 90° C. (Ohm-cm) | 21 | 13 | 38 | 90 | 3 |
| Volume Resistivity at 130° C. (Ohm-cm) | 28 | 42 | 27 | 803 | 1 |
| Elongation (after aging 7 d, 121° C.), % | N/m | N/m | N/m | N/m | N/m |
| (extruded tape) | | | | | |
| Elongation (after aging 7 d, 121° C.), % | N/m | N/m | 87 | 109 | 77 |
| (coated wire) | | | | | |
| Brittleness Failure Temperature, ° C. | ≤−30° C. | ≤−30° C. | ≤−30° C. | ≤−30° C. | ≤−30° C. |
| Surface Roughness, Rₐ, μm | 1.90 | 0.858 | N/m | N/m | N/m |
| (crosslinked extruded tape) | | | | | |
| Surface Roughness, Rₐ, μm | N/m | N/m | 0.358 | 1.01 | 0.513 |
| (crosslinked coated wire) | | | | | |
| Presence of Scorch Lumps (yes/no) | No | No | No | No | No |
| Wafer Boil Test (pass/fail) | N/m | N/m | Pass | Pass | Pass |

*N/m means not measured.
**2.5 wt % comes from using 2.9 wt % Catalyst MB-1.

Inventive Example 6 (IE6): inventive moisture-curable semiconductive formulation was prepared and tested according to the above described methods. See results described below in Table 3. IE6 was made by making an initial formulation that had all ingredients except the ingredients contributed by the Catalyst MB-1, and then mixing together 97.4 wt % of the initial formulation and 2.6 wt % of the Catalyst MB-1.

TABLE 3
Final Composition (wt %) and Properties of IE6.

| Ex. No. | IE6 |
|---|---|
| Curable Copolymer (A)-1, wt % | 48.7 |
| Polar Copolymer (B)-1, wt % | 19.5 |
| Carbon Black (C)-1, wt % | 0 |
| (BET-1 65 m²/g; OAN-1 190 mL/100 g) | |
| Carbon Black (C)-2, wt % | 0 |
| (BET-1 800 m²/g; OAN-1 338 mL/100 g) | |
| Carbon Black (C)-3, wt % | 29.2 |
| (BET-1 223-254 m²/g; OAN-1 192 mL/100 g) | |
| ULW-Carbon Black-1 | 0 |
| (BET-1 56 m²/g; OAN-1 125-145 mL/100 g) | |
| Catalyst (D)-1, wt % | 0.1 |
| Antioxidant (E)-1 , wt % | <0.1 |
| Antioxidant (E)-2 , wt % | <0.1 |
| Carrier Resin (F)-1, wt % | 2.4 |
| Total Amount, wt % | 100 |
| Gel Content (wt %) | 58 |
| Volume Resistivity at 90° C. (Ohm-cm) | 15 |
| Volume Resistivity at 130° C. (Ohm-cm) | 2 |
| Elongation (after aging 7 d, 121° C.), % | N/m |
| (extruded tape) | |
| Elongation (after aging 7 d, 121° C.), % | 122 |
| (coated wire) | |
| Brittleness Failure Temperature, ° C. | N/m |
| Surface Roughness, Rₐ, μm (crosslinked extruded tape) | N/m |
| Surface Roughness, Rₐ, μm (crosslinked coated wire) | 0.391 |
| Presence of Scorch Lumps (yes/no) | No |
| Wafer Boil Test (pass/fail) | Pass |

*N/m means not measured.
**2.2 wt % from using 2.6 wt % Catalyst MB-1.

The data in Tables 2 and 3 demonstrate unexpected results when compared to the data in Table 1.

The tapes data show that the inventive formulation having a carbon black with a BET total surface area greater than 200 m²/g can be made with good electrical conductivity and surface smoothness (low surface roughness). The surface smoothness is comparable to what can be achieved using smaller surface area carbon blacks in the terpolymer prior art.

The wire data show the invention is suitable for use as an extruded semiconductive layer in a wire or cable. The inventive formulation embodiments containing carbon black with high BET total surface areas (e.g., >200 m2/g) can be processed without scorch and comparable surface roughness (i.e., comparable surface smoothness) to lower BET total surface area carbon blacks. Unlike prior formulations, the inventive formulations do not require use of a carbon black having a narrowly defined BET total surface area in order to achieve acceptable performance as semiconductive layers of power cables. The inventive formulation can beneficially be extruded onto wire with a catalyst masterbatch did not exhibit sign of scorch.

The volume resistivity data show that the inventive formulations will be substantially more effective at prolonging service life of an electrical power cable containing a semiconductive layer composed of the inventive formulation by preventing or decreasing partial discharges at its interface with an adjacent component (e.g., the conductor core or insulation layer).

Inventive Examples 7 and 8 (IE7 and IE8): inventive moisture-curable semiconductive formulations were prepared and tested according to the above described methods. See results described below in Table 4.

TABLE 4
Final Compositions (wt %) and Properties of IE7 and IE8.

| Ex. No. | IE7 | IE8 |
|---|---|---|
| Curable Copolymer (A)-1, wt % | 55 | 50 |
| Polar Copolymer (B)-2, wt % | 20 | 20 |
| Carbon Black (C)-3, wt % | 25 | 30 |
| (BET-1 223-254 m²/g; OAN-1 192 mL/100 g) | | |
| Catalyst (D)-1, wt % | <0.1 | <0.1 |
| Antioxidant (E)-1 , wt % | <0.1 | <0.1 |
| Antioxidant (E)-2 , wt % | <0.1 | <0.1 |
| Carrier Resin (F)-1, wt % | 2 to 3 | 2 to 3 |
| Moisture Scavenger (H)-1, wt % | 0 | 0 |
| Total Amount, wt % | 100 | 100 |
| Gel Content (wt %) | 61 | 60 |
| Volume Resistivity at 90° C. (Ohm-cm) | 71 | 18 |
| Volume Resistivity at 130° C. (Ohm-cm) | 1783 | 137 |
| Elongation (after aging 7 d, 121° C.), % | 126 | 107 |
| (extruded tape) | | |
| Elongation (after aging 7 d, 121° C.), % | N/m | N/m |
| (coated wire) | | |
| Brittleness Failure Temperature, ° C. | N/m | N/m |
| Surface Roughness, Rₐ, μm | 1.025 | 0.475 |
| (crosslinked extruded tape) | | |
| Surface Roughness, Rₐ, μm | N/m | N/m |
| (crosslinked coated wire) | | |
| Presence of Scorch Lumps (yes/no) | No | No |
| Wafer Boil Test (pass/fail) | N/m | N/m |

N/m not measured.

The data in Tables 1 to 3 show that the invention works when the (B) polar copolymer is an ethylene/alkyl acrylate copolymer such as an ethylene/ethyl acrylate copolymer. The data in Table 4 show that the invention works when the (B) polar copolymer is an ethylene/vinyl acetate copolymer.

The volume resistivity data in Table 4 show that the inventive formulations will be substantially more effective at prolonging service life of an electrical power cable containing a semiconductive layer composed of the inventive formulation by preventing or decreasing partial discharges at its interface with an adjacent component (e.g., the conductor core or insulation layer). The tapes data show that the inventive formulation having a carbon black with a BET total surface area greater than 200 m²/g can be made with good electrical conductivity and surface smoothness (low surface roughness). The surface smoothness is comparable to what can be achieved using smaller surface area carbon blacks in the terpolymer prior art.

1. A moisture-curable semiconductive formulation consisting essentially of from 40.0 to 70.0 weight percent (wt %) of (A) an ethylene/(alkenyl-functional hydrolyzable silane)/(optional olefinic hydrocarbon) copolymer (“(A) Curable Copolymer” or, simply, “(A)”); from 16 to 34 wt % of (B) an ethylene/unsaturated carboxylic ester copolymer that is free of moisture curable groups (“(B) Polar Copolymer” or, simply, “(B)”); from 14.0 to 30.0 wt % of (C) a conventional carbon black (“(C) Carbon Black” or, simply, “(C)”); and a total amount of from 0 to 30.0 wt % of (X) at least one additive, which is not selected from (A), (B), and (C);
wherein the composition of the (A) ethylene/(alkenyl-functional hydrolyzable silane)/(optional olefinic hydrocarbon) copolymer is from 58.5 to 99.5 wt % of ethylenic units, from 0.5 to 5.0 wt % of comonomeric units derived from the alkenyl-functional hydrolyzable silane, and from 0 to 40 wt % of comonomeric units derived from one or more olefinic hydrocarbons, all based on weight of (A); and wherein the (A) ethylene/(alkenyl-functional hydrolyzable silane)/(optional olefinic hydrocarbon) copolymer has a melt index (I2, 190° C., 2.16 kg) from 1.2 to 1.7 grams per 10 minutes (g/10 min.);
wherein the composition of the (B) ethylene/(unsaturated carboxylic ester)(optional olefinic hydrocarbon) copolymer is from 60 to 95 wt % of ethylenic units and from 5 to 40 wt % of comonomeric units derived from the unsaturated carboxylic ester, and from 0 to 40 wt % of comonomeric units derived from one or more olefinic hydrocarbons, all based on weight of (B);
wherein the (C) Carbon Black has either: a Brunauer, Emmett and Teller (BET) total surface area (“BET-1”) from 205 to 840 square meters per gram (m2/g) measured by a multipoint nitrogen adsorption method according to ASTM D6556-19a (Standard Test Method for Carbon Black—Total and External Surface Area by Nitrogen Adsorption), or an oil absorption number (“OAN-1”) of greater than 185 milliliters oil per 100 grams carbon black (mL/100 g) measured according to ASTM D2414-19 (Standard Test Method for Carbon Black—Oil Absorption Number (OAN)), or both BET-1 and OAN-1;
wherein the (X) at least one additive comprises (D) a silanol condensation catalyst and/or (E) an antioxidant; and wherein the wt % of (A) in the formulation and the wt % of the comonomeric units derived from the alkenyl-functional hydrolyzable silane in (A) together are sufficient such that the amount of the comonomeric units derived from the alkenyl-functional hydrolyzable silane is from 0.7 to 3.0 wt % of the formulation; and
wherein the formulation has a volume resistivity measured at 130° C. of less than 100,000 Ohm-centimeters (Ohm-cm), as measured according to the Volume Resistivity Test Method.

2. The moisture-curable semiconductive formulation of claim 1 wherein the (A) Curable Copolymer has any one of limitations (i) to (v): (i) the optional olefinic hydrocarbon is absent and the (A) ethylene/(alkenyl-functional hydrolyzable silane)/(optional olefinic hydrocarbon) copolymer is an ethylene/(alkenyl-functional hydrolyzable silane) copolymer; (ii) the optional olefinic hydrocarbon is present and is a (C3-C40)alpha-olefin and the (A) ethylene/(alkenyl-functional hydrolyzable silane)/(optional olefinic hydrocarbon) copolymer is an ethylene/(alkenyl-functional hydrolyzable silane)/(C3-C40)alpha-olefin copolymer; (iii) the alkenyl-functional hydrolyzable silane is of formula H2C═C(Ra)—((C1-C20)alkylene)k-(C═O)j-((C1-C20)alkylene)k-Si(R)m(R1)3-m, wherein subscript j is 0 or 1; subscript k is 0 or 1; subscript m is 1, 2, or 3; Ra is H or methyl; each R independently is H, hydroxyl (—OH), an alkoxy, a carboxy, an N,N-dialkylamino, an alkyloximo, or a dialkyloximo; and each R1 independently is hydrocarbyl; (iv) both (i) and (iii); and (v) both (ii) and (iii).

3. The moisture-curable semiconductive formulation of claim 1 wherein the (B) Polar Copolymer has any one of limitations (i) to (vii): (i) (B) is an ethylene/ethyl acrylate copolymer or an ethylene/butyl acrylate copolymer; (ii) (B) is an ethylene vinyl acetate (EVA) copolymer; (iii) (B) is a blend of EEA and EVA, a blend of EBA and EVA, or a blend or EEA and EBA; (iv) (B) is from 16 to 22 wt % of the formulation; (v) (B) is from 26 to 32 wt % of the formulation; (vi) both (i) and (iv); and (vii) both (i) and (v).

4. The moisture-curable semiconductive formulation of claim 1 wherein the (C) Carbon Black has any one of limitations (i) to (vi): (i) the BET total surface area BET-1 is from 61 to 69 m2/g and the oil absorption number OAN-1 is greater than 185 mL/100 g; (ii) the BET total surface area BET-1 is from 221 to 259 m2/g and the oil absorption number OAN-1 is greater than 170 mL/100 g; (iii) the BET total surface area BET-1 is from 321 to 349 m2/g and the oil absorption number OAN-1 is greater than 170 mL/100 g; (iv) the BET total surface area BET-1 is from 755 to 844 m2/g and the oil absorption number OAN-1 is greater than 170 mL/100 g; (v) the oil absorption number OAN-1 is greater than 185 mL/100 g; (vi) the (C) Carbon Black is a furnace black.

5. The moisture-curable semiconductive formulation of claim 1 wherein the (X) at least one additive is present in the formulation and comprises the (D) silanol condensation catalyst and the (E) antioxidant; and optionally (F) a carrier resin, (G) a metal deactivator, or (H) a moisture scavenger, or a combination of any two or more of (F) to (H).

6. A method of making a moisture-curable semiconductive formulation of claim 1, the method comprising mixing the (C) Carbon Black into a pre-made blend of the (A) ethylene/(alkenyl-functional hydrolyzable silane)/(optional olefinic hydrocarbon) copolymer and (B) ethylene/(unsaturated carboxylic ester)(optional olefinic hydrocarbon) copolymer in such a way so as to make the moisture-curable semiconductive formulation.

7. A moisture-cured semiconductive product that is made by moisture curing the moisture-curable semiconductive formulation of claim 1 to give the moisture-cured semiconductive product, which has a crosslinked polyethylene network made by cross-linking molecules of the (A) ethylene/(alkenyl-functional hydrolyzable silane)/(optional olefinic hydrocarbon) copolymer and wherein the crosslinked polyethylene network contains dispersed therein the (B) ethylene/(unsaturated carboxylic ester)(optional olefinic hydrocarbon) copolymer and the (C) Carbon Black, and, optionally, the (X) at least one additive.

8. The moisture-cured semiconductive product of claim 7 having any one of the following properties (i) to (vii): (i) a gel content of greater than 40.0 wt %, as measured according the Gel Content Test Method; (ii) a volume resistivity measured separately at 90° C. and 130° C. of less than 10,000 Ohm-centimeters (Ohm-cm) each, as measured according to the Volume Resistivity Test Method; (iii) an elongation of greater than 100.0% after 7 days at 121° C., measured according to the Hot Creep and Elongation Test Method; (iv) a low-temperature brittleness failure at less than or equal to −25° C., determined according to the Low-Temperature Brittleness Test Method; (v) surface roughness, Ra, of less than 2.06 micrometers (μm), wherein Ra is the arithmetic average deviation above and below a center line of a stylus passing over the surface of the tape, measured according to the Surface Roughness Test Method; (vi) free of scorch lumps as determined according to the Scorch Lumps on Wire Insulation Test Method; and (vii) passes the Wafer Boil Test as determined according to the Wafer Boil Test Method.

9. A manufactured article comprising a shaped form of the moisture-cured semiconductive product of claim 7.

10. A method of making the manufactured article of claim 9, the method comprising shaping a melt of the moisture-curable semiconductive formulation to give a shaped moisture-curable semiconductive formulation, and then subjecting the shaped moisture-curable semiconductive formulation to moisture-curing conditions to give the manufactured article.

11. A coated conductor comprising a conductive core and a semiconductive layer at least partially surrounding the conductive core, wherein at least a portion of the semiconductive layer comprises the moisture-cured semiconductive product of claim 7.

12. A method of making the coated conductor of claim 11, the method comprising extruding a layer of a melt of the moisture-curable semiconductive formulation onto the conductive core to give a conductive core covered by the extruded layer of the moisture-curable semiconductive formulation, and then subjecting the extruded layer of moisture-curable semiconductive formulation to moisture-curing conditions to give the a coated conductor comprising the conductive core covered by the semiconductive layer.

13. A method of conducting electricity, the method comprising applying a voltage across the conductive core of the coated conductor of claim 11 so as to generate a flow of electricity through the conductive core.
